(19) United States
(12) Patent Application Publication
(10) Pub. No.: US 2025/0200973 A1
(43) Pub. Date: Jun. 19, 2025

(54) IMAGING DEVICE, IMAGING METHOD, AND IMAGING PROGRAM

(71) Applicant: SONY SEMICONDUCTOR SOLUTIONS CORPORATION, KANAGAWA (JP)

(72) Inventor: MASAAKI IKEDA, KANAGAWA (JP)

(21) Appl. No.: 18/847,984

(22) PCT Filed: Mar. 10, 2023
(86) PCT No.: PCT/JP2023/009243

§ 371 Date: Sep. 17, 2024

(30) Foreign Application Priority Data
Mar. 24, 2022 (JP) 2022-048481

(51) Int. Cl. G06V 20/52; G06T 7/70; G06V 10/147; G06V 10/25; G06V 10/70; H04N 25/44

(52) U.S. Cl. CPC G06V 20/52; G06T 7/70; G06V 10/147; G06V 10/25; G06V 10/70; H04N 25/44; G06T 2207/20081; G06T 2207/30232

(57) ABSTRACT

An imaging device according to an embodiment includes: an imaging unit (100) that has a pixel region in which a plurality of pixels is arranged in a matrix array, and reads and outputs a pixel signal from the pixel included in the pixel region; and a first processing unit (142) that infers, on the basis of the pixel signals of the pixels included in designated rows among the pixels included in the pixel region, presence or absence of a foreign object for each of the rows.

### FIELD

The present disclosure relates to an imaging device, an imaging method, and an imaging program.

### BACKGROUND

In recent years, with an increase in performance of an imaging device such as a small camera used for monitoring or the like, an imaging device equipped with an image recognition function for recognizing a predetermined object included in a captured image has been developed.

### CITATION LIST

### Patent Literature

Patent Literature 1: Japanese Patent Application Laid-Open No. 10-247241

### SUMMARY

### Technical Problem

However, conventionally, there is a problem that an increase in a processing time and compression of a memory area occur in order to execute an image recognition function.

An object of the present disclosure is to provide an imaging device, an imaging method, and an imaging program capable of suppressing a processing time and a memory area associated with implementation of an image recognition function.

### Solution to Problem

For solving the problem described above, an imaging device according to one aspect of the present disclosure has an imaging unit that has a pixel region in which a plurality of pixels is arranged in a matrix array, and reads and outputs a pixel signal from the pixel included in the pixel region; and a first processing unit that infers, on a basis of the pixel signals of the pixels included in designated rows among the pixels included in the pixel region, presence or absence of a foreign object for each of the rows.

### BRIEF DESCRIPTION OF DRAWINGS

FIG. 1 is a schematic diagram illustrating a configuration of an example of a monitoring system applicable to an embodiment.

FIG. 2 is a schematic diagram for schematically describing inference processing according to the embodiment of the present disclosure.

FIG. 3 is a block diagram illustrating a configuration of an example of an imaging device according to the embodiment.

FIG. 4 is a schematic diagram illustrating an example of a hardware configuration of an imaging device according to each embodiment.

FIG. 5A is a diagram illustrating an example in which the imaging device according to each embodiment is formed by a stacked CIS having a two-layer structure.

FIG. 5B is a diagram illustrating an example in which the imaging device according to each embodiment is formed by a stacked CIS having a three-layer structure.

FIG. 6 is a block diagram illustrating a configuration of an example of a sensor unit applicable to each embodiment.

FIG. 7 is a functional block diagram of an example for explaining a function of a recognition processing unit according to the embodiment.

FIG. 8 is a block diagram illustrating a hardware configuration of an example of a learning device according to the embodiment.

FIG. 9 is a schematic diagram for schematically explaining learning processing according to the embodiment.

FIG. 10A is a schematic diagram for more specifically explaining processing by supervised learning according to the embodiment.

FIG. 10B is a schematic diagram for more specifically explaining processing by supervised learning according to the embodiment.

FIG. 11A is a schematic diagram for more specifically explaining processing by unsupervised learning according to the embodiment.

FIG. 11B is a schematic diagram for more specifically explaining processing by unsupervised learning according to the embodiment.

FIG. 12 is a schematic diagram for explaining determination based on an abnormality degree calculated by a machine learning model by unsupervised learning.

FIG. 13 is a schematic diagram for explaining inference processing by a first processing unit according to the embodiment.

FIG. 14 is a sequence diagram of an example for explaining time-series transition of processing in the first processing unit according to the embodiment.

FIG. 15 is a schematic diagram for describing an input unit of image data input to a machine learning model applicable to the embodiment.

FIG. 16 is a schematic diagram for explaining an output unit of image data output from the machine learning model applicable to the embodiment.

FIG. 17 is a flowchart illustrating an example of inference processing by an inference processing unit according to the embodiment.

FIG. 18 is a schematic diagram illustrating an example of inference results before execution of integration processing by a second processing unit.

FIG. 19 is a schematic diagram for more specifically explaining moving average calculation processing of inference results according to the embodiment.

FIG. 20A is a schematic diagram for explaining an inference result output method according to the embodiment.

FIG. 20B is a schematic diagram for explaining an inference result output method according to the embodiment.

FIG. 21 is a schematic diagram illustrating an example of setting of a region of interest according to the embodiment.

FIG. 22 is a schematic diagram for schematically explaining a technique disclosed in Patent Literature 1 as an existing technique.

FIG. 23 is a schematic diagram for explaining a technique according to the embodiment of the present disclosure in comparison with the existing technique.

FIG. 24 is a block diagram illustrating a configuration of an example of an imaging device according to a modification of the embodiment.

### DESCRIPTION OF EMBODIMENTS

Hereinafter, embodiments of the present disclosure will be described in detail with reference to the drawings. Note that, in the following embodiments, the same parts are denoted by the same reference numerals, and redundant description will be omitted.

Hereinafter, embodiments of the present disclosure will be described in the following order.
1. Embodiment
1-1. Outline of embodiment
1-2. Configuration according to embodiment
1-3. Processing according to embodiment
1-3-1. Learning processing according to embodiment
1-3-2. Details of inference processing according to embodiment
1-3-3. About setting of region of interest
1-4. Comparison with existing technique
2. Modification of embodiment

### 1. Embodiment

An embodiment of the present disclosure will be described. In the embodiment of the present disclosure, a fixed camera attached to a fixed object such as a wall, a pillar, or a ceiling and used for an application such as a monitoring camera that performs imaging in a fixed imaging range is assumed as an imaging device. In the embodiment, presence or absence of a foreign object is detected for each line designated by a user, for example, in an image captured by the fixed camera. The user may designate a line for detecting the presence or absence of the foreign object as an intermittent line with respect to the captured image.

In the fixed camera, a probability distribution of pixel values in the captured image is fixed to some extent. Therefore, a background and a row number for each line read from an imaging element (a pixel array) in a sensor included in the fixed camera are learned by machine learning, and a machine learning model for inferring whether or not the background includes a foreign object is constructed. In the machine learning model, deviation of several pixels in the image of the line is learned as the background. A one-dimensional convolutional neural network (CNN) that performs line-by-line convolution, that is, one-dimensional convolution can be applied to the machine learning model constructed here, and the machine learning model can be made lightweight.

Note that the “background” refers to a region or an object that does not substantially change with time in the captured image. Furthermore, the “foreign object” refers to an object that appears at an arbitrary timing with respect to the “background” and is different from the background. The “foreign object” may be a person or an animal. Further, the “foreign object” may be a machine (robot) that operates autonomously or according to control. Furthermore, the “foreign object” may be a state in which an object as a part of a background image is damaged or destroyed.

In the embodiment of the present disclosure, since image recognition related to the detection of the presence or absence of the foreign object is executed for each line, it is possible to suppress a processing time and a memory area associated with implementation of an image recognition function.

### 1-1. Outline of Embodiment

First, an outline of the embodiment will be described.

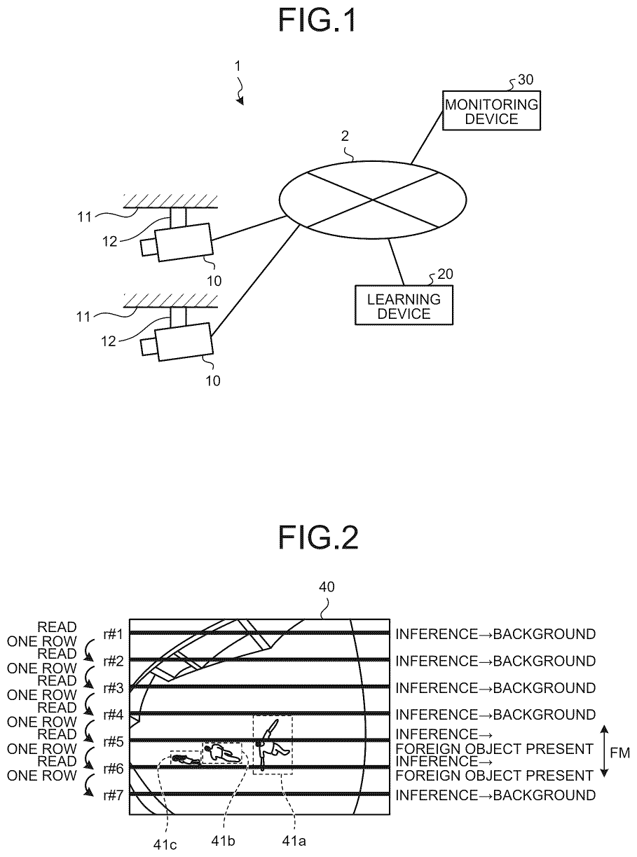

FIG. 1 is a schematic diagram illustrating a configuration of an example of a monitoring system applicable to the embodiment. In FIG. 1, a monitoring system 1 includes an imaging device 10, a learning device 20, and a monitoring device 30 that are communicably connected to each other by a network 2. The network 2 may be the Internet or a local area network (LAN) constructed in a specific facility. Not limited to this, the imaging device 10, the learning device 20, and the monitoring device 30 may be directly connected by a cable or the like.

The imaging device 10 is used by being attached to a fixed object 11 such as a ceiling of a building by a fitting 12. In this example, the imaging device 10 is attached with an imaging range fixed by the fitting 12. That is, the imaging device 10 in this example always keeps imaging the same imaging range at the time of use.

The imaging device 10 includes an imaging element including a pixel array in which pixels that output pixel signals according to received light are arranged in a matrix array and a recognition processing unit that performs recognition processing on the basis of a captured image captured by the imaging element. The recognition processing unit included in the imaging device 10 performs the recognition processing on an image of a designated line in the captured image by using a machine learning model learned in advance by machine learning, and infers presence or absence of a foreign object. The imaging device 10 can output the captured image and an inference result of the presence or absence of the foreign object to, for example, the network 2.

For example, a general computer can be applied to the learning device 20, and the learning device performs learning by machine learning on the basis of an image of a designated line in a captured image output from the imaging device 10 and constructs a machine learning model. The learning device 20 transmits the machine learning model constructed on the basis of the captured image to the imaging device 10 that has output the captured image. In a case where the monitoring system 1 includes a plurality of imaging devices 10, the learning device 20 can construct a machine learning model based on the captured image for each of the plurality of imaging devices 10.

Furthermore, the learning device 20 can designate a line on which recognition processing is performed for the imaging device 10, for example, in accordance with a user operation. In a case where the monitoring system 1 includes the plurality of imaging devices 10, the learning device 20 can designate the line according to the user operation for each of the plurality of imaging devices 10.

Note that FIG. 1 illustrates that the imaging device 10 and the learning device 20 are connected via the network 2, but this is not limited to this example. For example, the imaging device 10 and the learning device 20 may be directly connected by priority or wireless communication without passing through the network 2.

The monitoring device 30 can cause a display apparatus to display the captured image output from the imaging device 10 and the inference result of the presence or absence of the foreign object. In addition, the monitoring device 30 may make a predetermined notification to the user on the basis of the inference result of the presence or absence of the foreign object.

FIG. 2 is a schematic diagram for schematically describing inference processing according to the embodiment of the present disclosure. In FIG. 2, a captured image 40 output from the imaging element of imaging device 10 includes, for example, foreign objects 41a, 41b, and 41c that are persons with respect to a background image. Furthermore, in an example of FIG. 2, lines for inferring presence or absence of a foreign object with respect to the captured image 40 output from the imaging element of the imaging device 10 are designated by rows r #1, r #2, . . . of a pixel arrangement in the pixel array. The rows r #1, r #2, . . . are intermittently designated with respect to the rows included in the pixel arrangement. In other words, the rows r #1, r #2, . . . designate the rows r #1, r #2, . . . at an interval of one or more rows with respect to the rows included in the pixel arrangement.

When a line indicated by the row r #1 is read from the imaging element, the imaging device 10 executes processing of inferring the presence or absence of a foreign object on the read line. When a line indicated by the next row r #2 is read from the imaging element, the imaging device 10 executes the processing of inferring the presence or absence of the foreign object on the read line. As described above, every time the lines indicated by the rows r #1, r #2, . . . are read, the imaging device 10 executes the processing of inferring the presence or absence of the foreign object on the basis of an image of the read line.

In the example of FIG. 2, the imaging device 10 infers that images of lines indicated by rows #1 to #4 and a row #7 are “background” (no foreign object). On the other hand, since images of lines indicated by rows #5 and #6 include some of the images of the foreign objects 41a, 41b, and 41c, the imaging device 10 infers that “foreign object present”. The imaging device 10 may output an inference result of each of the rows #1 to #7, or may output a range FM including the rows #5 and #6 inferred as “foreign object present” as the inference result.

As described above, in the embodiment of the present disclosure, since the presence or absence of the foreign object is inferred for each line, it is possible to suppress a calculation amount, a calculation time, and a memory size related to the processing.

Note that, in the example of FIG. 2, the imaging device 10 reads lines from an upper end to a lower end of the captured image 40, but this is not limited to this example. That is, reading order of the lines in the captured image 40 may be arbitrary. Furthermore, the interval of the lines to be read may be appropriately set, for example, according to a monitoring target.

### 1-2. Configuration According to Embodiment

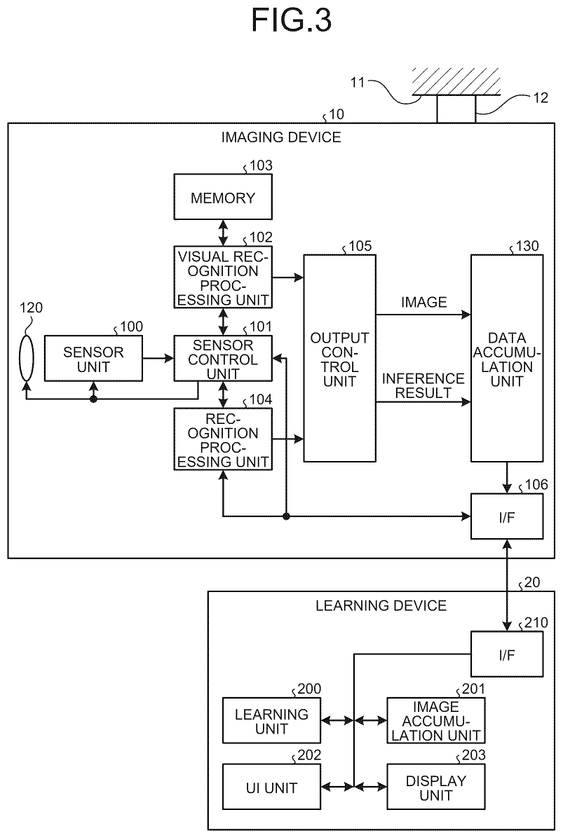

Next, a configuration according to the embodiment will be described. FIG. 3 is a block diagram illustrating a configuration of an example of the imaging device according to the embodiment. As illustrated in FIG. 3, the imaging device 10 according to the embodiment is attached to the fixed object 11 such as a ceiling, a wall, or a pillar by the fitting 12, and is used with a fixed imaging range.

In FIG. 3, the imaging device 10 includes a sensor unit 100, a sensor control unit 101, a visual recognition processing unit 102, a memory 103, a recognition processing unit 104, an output control unit 105, an interface (I/F) 106, and a data accumulation unit 130. The sensor unit 100, the sensor control unit 101, the visual recognition processing unit 102, the memory 103, the recognition processing unit 104, the output control unit 105, the I/F 106, and the data accumulation unit 130 are configured as a complementary metal oxide semiconductor (CMOS) image sensor (CIS) integrally formed using a CMOS, for example.

Not limited to this, some or all of the sensor unit 100, the sensor control unit 101, the visual recognition processing unit 102, the memory 103, the recognition processing unit 104, the output control unit 105, the I/F 106, and the data accumulation unit 130 may be configured by independent hardware circuits that operate in cooperation with each other.

The sensor unit 100 outputs a pixel signal corresponding to light with which a light receiving surface is irradiated via an optical unit 120. More specifically, the sensor unit 100 includes a pixel array in which pixels including at least one photoelectric conversion element are arranged in a matrix. The light receiving surface is formed by the pixels arranged in a matrix in the pixel array. The sensor unit 100 further includes a drive circuit for driving each pixel included in the pixel array, and a signal processing circuit that performs predetermined signal processing on a signal read from each pixel and outputs the signal as a pixel signal of each pixel. The sensor unit 100 outputs a pixel signal of each pixel included in a pixel region as image data in a digital format.

Hereinafter, in the pixel array included in the sensor unit 100, a region in which effective pixels for generating pixel signals are arranged is referred to as a frame. Frame image data is formed by pixel data based on each pixel signal output from each pixel included in the frame. Furthermore, each row in the arrangement of pixels of the sensor unit 100 is referred to as a line, and line image data is formed by pixel data based on a pixel signal output from each pixel included in the line. Furthermore, an operation in which the sensor unit 100 outputs a pixel signal corresponding to the light with which the light receiving surface is irradiated referred to as imaging. The sensor unit 100 controls exposure and a gain (an analog gain) for a pixel signal at the time of imaging in accordance with an imaging control signal supplied from the sensor control unit 101 to be described later.

The sensor control unit 101 includes, for example, a microprocessor, controls reading of pixel data from the sensor unit 100 according to a program, and outputs pixel data based on each pixel signal read from each pixel included in the frame. The pixel data output from the sensor control unit 101 is passed to the visual recognition processing unit 102 and the recognition processing unit 104. The sensor control unit 101 may control operations of the visual recognition processing unit 102 and the recognition processing unit 104 according to the program.

Furthermore, the sensor control unit 101 generates an imaging control signal for controlling imaging in the sensor unit 100. The sensor control unit 101 generates the imaging control signal, for example, in accordance with instructions from the visual recognition processing unit 102 and the recognition processing unit 104 to be described later. The imaging control signal includes information indicating the exposure and the analog gain at the time of imaging in the sensor unit 100 described above. The imaging control signal further includes a control signal (a vertical synchronization signal, a horizontal synchronization signal, or the like.) used by the sensor unit 100 to perform an imaging operation. The sensor control unit 101 supplies the generated imaging control signal to the sensor unit 100.

The optical unit 120 is for irradiating the light receiving surface of the sensor unit 100 with light from a subject, and is arranged at a position corresponding to the sensor unit 100, for example. The optical unit 120 includes, for example, a plurality of lenses, a diaphragm mechanism for adjusting a size of an opening with respect to incident light, a focus mechanism for adjusting a focus of light with which the light receiving surface is irradiated, and a zoom mechanism for adjusting an angle of view. The optical unit 120 may further include a shutter mechanism (mechanical shutter) that adjusts a time during which the light receiving surface is irradiated with light.

The diaphragm mechanism, the focus mechanism, the shutter mechanism, and the zoom mechanism included in the optical unit 120 can be controlled by the sensor control unit 101. Not limited to this, the diaphragm, the focus, and the zoom in the optical unit 120 can also be controlled from the outside of the imaging device 10. Furthermore, the optical unit 120 can be configured integrally with the imaging device 10.

The visual recognition processing unit 102 executes processing for obtaining an image suitable for human visual recognition on pixel data passed from the sensor control unit 101 using the memory 103, and outputs image data including a group of pixel data, for example. For example, the visual recognition processing unit 102 includes an image signal processor (ISP), and the ISP reads and executes a program stored in advance in a memory (not illustrated), thereby configuring the visual recognition processing unit 102. For example, the visual recognition processing unit 102 stores image data read from the sensor unit 100 in the memory 103. When a predetermined amount of image data is stored in the memory 103, the visual recognition processing unit 102 performs predetermined image processing on the image data stored in the memory 103.

For example, in a case where a color filter is provided for each pixel included in the sensor unit 100 and the pixel data has color information of red (R), green (G), and blue (B), the visual recognition processing unit 102 can execute demosaic processing, white balance processing, and the like. Furthermore, the visual recognition processing unit 102 can instruct the sensor control unit 101 to read pixel data necessary for visual recognition processing from the sensor unit 100. For example, the visual recognition processing unit 102 may instruct the sensor control unit 101 to read pixel data for one frame from the sensor unit 100. The image data subjected to the image processing of the pixel data by the visual recognition processing unit 102 is passed to the output control unit 105.

On the basis of image data delivered from the sensor control unit 101, the recognition processing unit 104 performs recognition processing of an object included in an image based on the image data. In the present disclosure, the recognition processing unit 104 includes, for example, a digital signal processor (DSP), and the DSP reads and executes a program learned in advance by supervised learning or unsupervised learning and stored in the memory 103 as a learned machine learning model, thereby performing recognition processing using a deep neural network (DNN).

The recognition processing unit 104 can instruct the sensor control unit 101 to read pixel data necessary for the recognition processing from the sensor unit 100. In the embodiment, the recognition processing unit 104 instructs the sensor control unit 101 to read pixel data of a designated line (row) from the sensor unit 100. In the embodiment, the recognition processing unit 104 infers presence or absence of a foreign object for each line by the recognition processing. An inference result (a recognition result) of each line by the recognition processing unit 104 is passed to the output control unit 105.

The output control unit 105 includes, for example, a microprocessor, and passes the inference result of each line passed from the recognition processing unit 104 and the image data passed from the visual recognition processing unit 102 as a visual recognition processing result to the data accumulation unit 130.

The data accumulation unit 130 includes a memory and stores the inference result of each line passed from the recognition processing unit 104 and the image data passed from the visual recognition processing unit 102. The data accumulation unit 130 can output one or both of the stored inference result and image data to the outside of the imaging device 10, for example, in response to a request from a device outside the imaging device 10. In addition, the data accumulation unit 130 passes the stored image data to the I/F 106 in response to a request from the learning device 20, for example. The data accumulation unit 130 may further pass the stored inference result of each line to the I/F 106.

The I/F 106 is an interface for transmitting and receiving data and the like to and from the learning device 20. The I/F 106 may be, for example, an interface that communicates with the network 2. Furthermore, since the imaging device 10 is used as a fixed camera with a fixed imaging range, it is preferable that the I/F 106 supports wireless communication because it is possible to suppress blurring of the imaging range due to contact, impact, or the like.

The I/F 106 transmits image data passed from the data accumulation unit 130 to the learning device 20. Similarly, the I/F 106 transmits the image data passed from the data accumulation unit 130 to the monitoring device 30. When an inference result of each line is passed from the data accumulation unit 130, the I/F 106 may transmit the inference result to the learning device 20 or the monitoring device 30.

In addition, the I/F 106 receives data transmitted from the learning device 20. For example, the I/F 106 receives a machine learning model transmitted from the learning device 20 and passes the received machine learning model to the recognition processing unit 104. In addition, for example, the I/F 106 receives information indicating a row number transmitted from the learning device 20 and passes the received information indicating the row number to the sensor control unit 101.

Hereinafter, unless otherwise specified, the “information indicating a row number” is simply referred to as a “row number”.

In FIG. 3, the learning device 20 includes a learning unit 200, an image accumulation unit 201, a user interface (UI) unit 202, a display unit 203, and an interface (I/F) 210.

The I/F 210 is an interface for transmitting and receiving data and the like to and from the imaging device 10. The I/F 210 receives image data transmitted from the imaging device 10 and passes the image data to the image accumulation unit 201. The image accumulation unit 201 stores the image data passed from the I/F 210 in a storage medium such as a memory.

The learning unit 200 extracts, for example, line image data designated by the UI unit 202 from the image data stored in the image accumulation unit 201, performs learning regarding inference of presence or absence of a foreign object by supervised learning or unsupervised learning by machine learning, and constructs a machine learning model. The learning unit 200 transmits the constructed machine learning model to the imaging device 10 from the I/F 210. In the imaging device 10, the I/F 106 receives the machine learning model transmitted from the learning device 20 and passes the received machine learning model to the recognition processing unit 104.

The UI unit 202 constitutes an interface related to a user operation. The UI unit 202 receives, for example, a user operation on an input device (such as a keyboard) included in the learning device 20. Furthermore, the UI unit 202 generates an image to be presented to the user, and passes the generated image to the display unit 203. The display unit 203 generates display control information for displaying the image passed from the UI unit 202 on a display apparatus (not illustrated).

In the UI unit 202, for example, information on a row number (a row number and a column number in some cases) indicating a line for inferring presence or absence of a foreign object is input by a user operation, and a line for performing the inference is designated. As the row number, for example, intermittent row numbers are designated in row numbers that increase by one for each row. The intermittent row numbers mean that one or more undesignated row numbers are included between the designated row numbers. The UI unit 202 transmits the input row number to the imaging device 10 from the I/F 210. In the imaging device 10, the I/F 106 receives the row number transmitted from the learning device 20 and passes the received row number to the recognition processing unit 104.

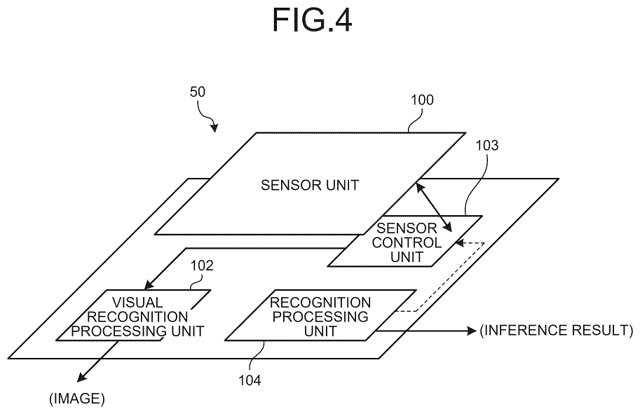

FIG. 4 is a schematic diagram illustrating an example of a hardware configuration of the imaging device 10 according to each embodiment. In the example of FIG. 4, in the configuration illustrated in FIG. 1, the sensor unit 100, the sensor control unit 101, the recognition processing unit 104, the memory 103, the visual recognition processing unit 102, the output control unit 105, the I/F 106, and the data accumulation unit 130 are mounted on one chip 50. Note that, in FIG. 4, the memory 103, the output control unit 105, the I/F 106, and the data accumulation unit 130 are omitted to avoid complexity. Note that the data accumulation unit 130 may be configured outside the chip 50.

In the configuration illustrated in FIG. 4, an inference result by the recognition processing unit 104 is output to the outside of the chip 50 via the I/F 106 (not illustrated). Furthermore, in the configuration of FIG. 4, the recognition processing unit 104 can acquire pixel data (line image data) for use in recognition from the sensor control unit 101 via an interface inside the chip 50.

In the above-described configuration illustrated in FIG. 4, the imaging device 10 can be formed on one substrate. Not limited to this, the imaging device 10 may be a stacked CIS in which a plurality of semiconductor chips is stacked and integrally formed.

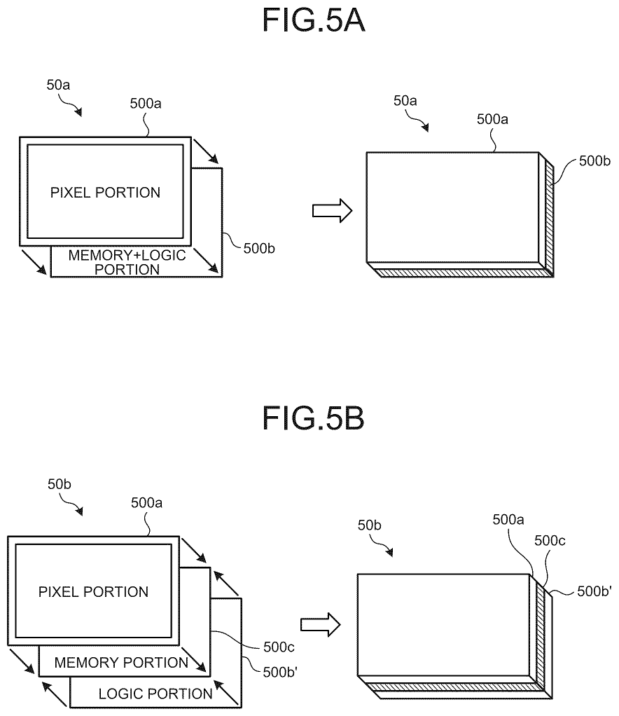

As an example, the imaging device 10 can be formed with a two-layer structure in which semiconductor chips are stacked in two layers. FIG. 5A is a diagram illustrating an example in which the imaging device 10 according to each embodiment is formed by a stacked CIS having a two-layer structure. In the structure of FIG. 5A, a pixel portion 500a is formed in the semiconductor chip of the first layer, and a memory+logic portion 500b is formed in the semiconductor chip of the second layer. The pixel portion 500a includes at least the pixel array in the sensor unit 100. The memory+logic portion 500b includes, for example, the sensor control unit 101, the recognition processing unit 104, the memory 103, the visual recognition processing unit 102, the output control unit 105, and the I/F 106. The memory+logic portion 500b further includes a part or all of the drive circuit that drives the pixel array in the sensor unit 100.

As illustrated on a right side of FIG. 5A, the imaging device 10 is configured as one solid-state imaging element by bonding the semiconductor chip of the first layer and the semiconductor chip of the second layer while electrically contacting each other.

As another example, the imaging device 10 can be formed with a three-layer structure in which semiconductor chips are stacked in three layers. FIG. 5B is a diagram illustrating an example in which the imaging device 10 according to each embodiment is formed by a stacked CIS having a three-layer structure. In the structure of FIG. 5B, the pixel portion 500a is formed in the semiconductor chip of the first layer, a memory portion 500c is formed in the semiconductor chip of the second layer, and a logic portion 500b′ is formed in the semiconductor chip of the third layer. In this case, the logic portion 500b′ includes, for example, the sensor control unit 101, the recognition processing unit 104, the visual recognition processing unit 102, the output control unit 105, and the I/F 106. Furthermore, the memory portion 500c can include the memory 103 and, for example, a memory used by the recognition processing unit 104 for recognition processing. The memory may be included in the logic portion 500b′.

As illustrated on a right side of FIG. 5B, the imaging device 10 is configured as one solid-state imaging element by bonding the semiconductor chip of the first layer, the semiconductor chip of the second layer, and the semiconductor chip of the third layer while electrically contacting each other.

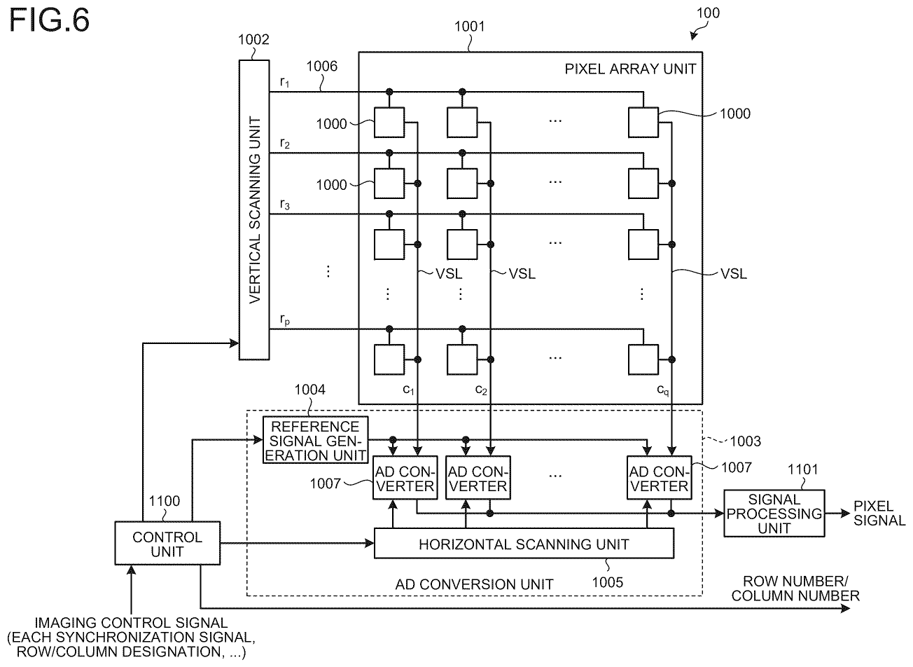

FIG. 6 is a block diagram illustrating a configuration of an example of the sensor unit 100 applicable to each embodiment. In FIG. 6, the sensor unit 100 includes a pixel array unit 1001, a vertical scanning unit 1002, an analog to digital (AD) conversion unit 1003, a pixel signal line 1006, a vertical signal line VSL, a control unit 1100, and a signal processing unit 1101. Note that, in FIG. 6, the control unit 1100 and the signal processing unit 1101 can also be included in the sensor control unit 101 illustrated in FIG. 1, for example.

The pixel array unit 1001 includes a plurality of pixel circuits 1000 each including, for example, a photoelectric conversion element by a photodiode that performs photoelectric conversion on received light and a circuit that reads electric charge from the photoelectric conversion element. In the pixel array unit 1001, the plurality of pixel circuits 1000 is arranged in a matrix array in a horizontal direction (row direction) and a vertical direction (column direction). In the pixel array unit 1001, the arrangement of the pixel circuits 1000 in the row direction is referred to as a line. In the example of FIG. 6, in each of rows r₁, r₂, . . . , rₚ, a line is configured by the plurality of pixel circuits 1000 included in the row rₙ.

For example, in a case where an image of one frame is formed with 1920 pixels×1080 lines, the pixel array unit 1001 includes at least 1080 lines including at least 1920 pixel circuits 1000. An image (image data) of one frame is formed by pixel signals read from the pixel circuits 1000 included in the frame.

The line may also be referred to simply as a “row”. Further, each line can be identified by a line number. For example, a number that increases by one from one end to another end of the pixel array unit 1001 can be applied to the line number. In the example of FIG. 6, the line number of the row r₁ on an upper end side in the diagram of the pixel array unit 1001 is set to “1”, and is incremented by 1 such as “2”, “3”, . . . , “p” for each line toward a lower end side.

Hereinafter, an operation of reading the pixel signal from each pixel circuit 1000 included in the frame in the sensor unit 100 will be described as reading a pixel from the frame as appropriate. Furthermore, an operation of reading the pixel signal from each pixel circuit 1000 included in the line included in the frame will be described as reading the line, reading the line image, or the like as appropriate. Furthermore, a row with a row number n in the pixel array unit 1001 is described as a row rₙ, and is distinguished from a row r #n intermittently designated from the captured image.

In the pixel array unit 1001, for a row and a column of each pixel circuit 1000, the pixel signal line 1006 is connected to each row, and the vertical signal line VSL is connected to each column. An end of the pixel signal line 1006 that is not connected to the pixel array unit 1001 is connected to the vertical scanning unit 1002. The vertical scanning unit 1002 transmits a control signal such as a drive pulse at the time of reading a pixel signal from a pixel to the pixel array unit 1001 via the pixel signal line 1006 under the control of the control unit 1100 described later. An end of the vertical signal line VSL that is not connected to the pixel array unit 1001 is connected to the AD conversion unit 1003. The pixel signal read from the pixel is transmitted to the AD conversion unit 1003 via the vertical signal line VSL.

Reading control of the pixel signal from the pixel circuit 1000 will be schematically described. Reading of the pixel signal from the pixel circuit 1000 is performed by transferring the electric charge accumulated in the photoelectric conversion element by exposure to a floating diffusion (FD) layer and by converting the transferred electric charge into a voltage in the floating diffusion layer. The voltage obtained by converting the electric charge in the floating diffusion layer is output to the vertical signal line VSL via an amplifier.

More specifically, in the pixel circuit 1000, during exposure, a space between the photoelectric conversion element and the floating diffusion layer is set to an off (open) state, and the electric charge generated according to light incident by photoelectric conversion is accumulated in the photoelectric conversion element. After the exposure is completed, the floating diffusion layer and the vertical signal line VSL are connected according to a selection signal supplied via the pixel signal line 1006. Further, the floating diffusion layer is connected to a supply line of a power supply voltage VDD or a black level voltage in a short period of time according to a reset pulse supplied via the pixel signal line 1006, and the floating diffusion layer is reset. A voltage (referred to as a voltage A) of a reset level of the floating diffusion layer is output to the vertical signal line VSL. Thereafter, the space between the photoelectric conversion element and the floating diffusion layer is set to an on (closed) state by a transfer pulse supplied via the pixel signal line 1006, and the electric charge accumulated in the photoelectric conversion element is transferred to the floating diffusion layer. A voltage (referred to as a voltage B) corresponding to a charge amount of the floating diffusion layer is output to the vertical signal line VSL.

The AD conversion unit 1003 includes an AD converter 1007 provided for each vertical signal line VSL, a reference signal generation unit 1004, and a horizontal scanning unit 1005. The AD converter 1007 is a column AD converter that performs AD conversion processing on each column (column) of the pixel array unit 1001. The AD converter 1007 performs the AD conversion processing on the pixel signal supplied from the pixel circuit 1000 via the vertical signal line VSL, and generates two digital values (values corresponding to the voltage A and the voltage B) for correlated double sampling (CDS) processing for noise reduction.

The AD converter 1007 supplies the generated two digital values to the signal processing unit 1101. The signal processing unit 1101 performs the CDS processing on the basis of the two digital values supplied from the AD converter 1007, and generates a pixel signal (pixel data) by a digital signal. The pixel data generated by the signal processing unit 1101 is output to the outside of the sensor unit 100.

On the basis of a control signal input from the control unit 1100, the reference signal generation unit 1004 generates, as a reference signal, a ramp signal used by each AD converter 1007 to convert a pixel signal into two digital values. The ramp signal is a signal in which a level (voltage value) decreases at a constant inclination with respect to time, or a signal in which the level decreases stepwise. The reference signal generation unit 1004 supplies the generated ramp signal to each AD converter 1007. The reference signal generation unit 1004 is configured using, for example, a digital-to-analog converter (DAC) or the like.

When a ramp signal whose voltage drops stepwise according to a predetermined inclination is supplied from the reference signal generation unit 1004, a counter starts counting according to a clock signal. A comparator compares the voltage of the pixel signal supplied from the vertical signal line VSL with the voltage of the ramp signal, and causes to stop counting by the counter at timing when the voltage of the ramp signal exceeds the voltage of the pixel signal. The AD converter 1007 converts a pixel signal by an analog signal into a digital value by outputting a value corresponding to a count value of a time when the counting is stopped.

The AD converter 1007 supplies the generated two digital values to the signal processing unit 1101. The signal processing unit 1101 performs the CDS processing on the basis of the two digital values supplied from the AD converter 1007, and generates a pixel signal (pixel data) by a digital signal. The pixel signal by the digital signal generated by the signal processing unit 1101 is output to the outside of the sensor unit 100.

Under the control of the control unit 1100, the horizontal scanning unit 1005 performs selective scanning to select each AD converter 1007 in a predetermined order, thereby sequentially outputting each digital value temporarily held by each AD converter 1007 to the signal processing unit 1101. The horizontal scanning unit 1005 is configured using, for example, a shift register, an address decoder, and the like.

The control unit 1100 performs drive control of the vertical scanning unit 1002, the AD conversion unit 1003, the reference signal generation unit 1004, the horizontal scanning unit 1005, and the like in accordance with an imaging control signal supplied from the sensor control unit 101. The imaging control signal may include a vertical synchronization signal or an external trigger signal and a horizontal synchronization signal. Furthermore, the imaging control signal may include a row number indicating a row from which a pixel signal is read. The imaging control signal may include a column number indicating a column from which a pixel signal is read.

The control unit 1100 generates various drive signals serving as references for operations of the vertical scanning unit 1002, the AD conversion unit 1003, the reference signal generation unit 1004, and the horizontal scanning unit 1005. The control unit 1100 generates a control signal for the vertical scanning unit 1002 to supply to each pixel circuit 1000 via the pixel signal line 1006 on the basis of, for example, the vertical synchronization signal or the external trigger signal and the horizontal synchronization signal included in the imaging control signal. The control unit 1100 supplies the generated control signal to the vertical scanning unit 1002.

Furthermore, for example, the control unit 1100 passes, to the AD conversion unit 1003, information indicating an analog gain included in the imaging control signal supplied from the sensor control unit 101. The AD conversion unit 1003 controls a gain of a pixel signal input to each AD converter 1007 included in the AD conversion unit 1003 via the vertical signal line VSL according to the information indicating the analog gain.

On the basis of a control signal supplied from the control unit 1100, the vertical scanning unit 1002 supplies various signals including a drive pulse to the pixel signal line 1006 of the selected pixel row of the pixel array unit 1001 to each pixel circuit 1000 for each line, and causes each pixel circuit 1000 to output a pixel signal to the vertical signal line VSL. At this time, the vertical scanning unit 1002 can read the pixel signal from each pixel circuit 1000 of the line of the row rₙ designated by the row number of the pixel array unit 1001 according to the row number included in the control signal supplied from the control unit 1100.

The vertical scanning unit 1002 is configured using, for example, a shift register, an address decoder, and the like. Furthermore, the vertical scanning unit 1002 controls exposure in each pixel circuit 1000 according to the information indicating the exposure supplied from the control unit 1100.

Note that the control unit 1100 outputs a row number of the row rₙ in which reading of the pixel signal is instructed by the vertical scanning unit 1002 to the outside of the sensor unit 100. In a case where a column from which the pixel signal is read is further instructed, the control unit 1100 outputs a column number indicating a column Cn in which the reading is instructed to the outside of the sensor unit 100. In a case where the column from which the pixel signal is read is instructed, the control unit 1100 can selectively output the pixel signal of the instructed column, for example, by controlling the output of each AD converter 1007.

The sensor unit 100 configured as described above is a column AD type complementary metal oxide semiconductor (CMOS) image sensor in which the AD converter 1007 is arranged for each column.

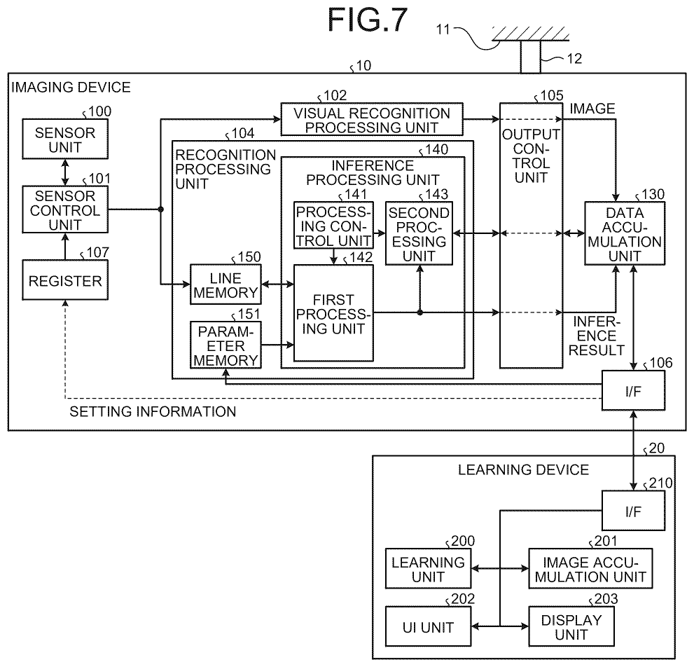

FIG. 7 is a functional block diagram of an example for explaining a function of the recognition processing unit 104 according to the embodiment.

Note that, in FIG. 7, the learning device 20 generates a row number designating a row rₙ to be read from the sensor unit 100 in response to, for example, a user operation on the UI unit 202, and transmits the generated row number to the imaging device 10 from the I/F 210. The imaging device 10 receives the row number transmitted from the learning device 20 by the I/F 106, and writes the row number in a register 107 as setting information for the sensor unit 100. The sensor control unit 101 reads the setting information from the register 107 and instructs reading of the row rₙ indicated by the row number indicated by the setting information. Furthermore, the learning device 20 transmits a machine learning model constructed by the learning unit 200 to the imaging device 10 from the I/F 210.

In FIG. 7, the recognition processing unit 104 includes an inference processing unit 140, a line memory 150, and a parameter memory 151.

The line memory 150 has a capacity capable of storing at least pixel data included in one line in the sensor unit 100. The line memory 150 stores pixel data included in one line indicated by the row number read from the sensor unit 100 according to the row number read from the register 107 by the sensor control unit 101. The parameter memory 151 stores the machine learning model constructed by the learning unit 200 transmitted from the learning device 20 and received by the I/F 106.

Hereinafter, pixel data included in one line is referred to as line image data, and an image based on the line image data is referred to as a line image.

The inference processing unit 140 includes a processing control unit 141, a first processing unit 142, and a second processing unit 143. The processing control unit 141 controls operations of the first processing unit 142 and the second processing unit 143.

The first processing unit 142 executes processing of inferring presence or absence of a foreign object on the line image data stored in the line memory 150 using the machine learning model stored in the parameter memory 151. An inference result of the presence or absence of the foreign object by the first processing unit 142 is passed to the second processing unit 143 together with the row number corresponding to the line image data. In addition, the inference result is passed to the output control unit 105 together with the row number corresponding to the line image data, and is stored in the data accumulation unit 130. As described above, the first processing unit 142 functions as a processing unit that infers presence or absence of a foreign object for each row on the basis of the pixel signal of the pixel included in the designated row among the pixels included in the pixel region.

The second processing unit 143 determines a position of the foreign object using the inference result by the first processing unit 142 stored in the data accumulation unit 130. For example, the second processing unit 143 acquires, from the data accumulation unit 130, the inference result of the line (row) by the first processing unit 142 and the row number of the line (row) for which the inference result has been obtained. The second processing unit 143 determines the position of the foreign object in the captured image captured by the sensor unit 100 on the basis of each inference result by the first processing unit 142 for each line included in a set, the set including three or more lines (rows) arranged continuously among the rows of which row numbers are designated intermittently.

The second processing unit 143 stores information indicating the determined position of the foreign object in the data accumulation unit 130 via the output control unit 105.

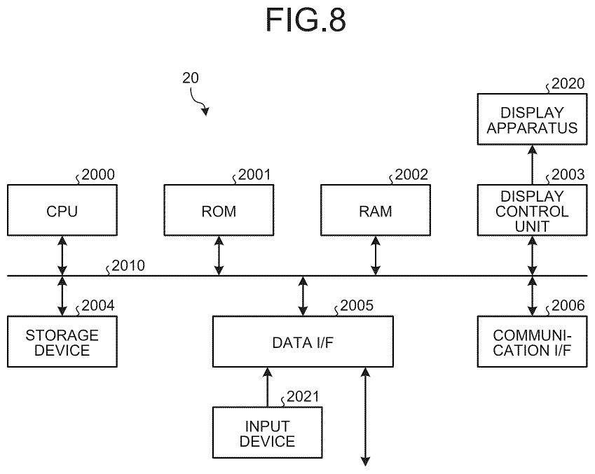

FIG. 8 is a block diagram illustrating a hardware configuration of an example of the learning device 20 according to the embodiment.

In FIG. 8, the learning device 20 includes a central processing unit (CPU) 2000, a read only memory (ROM) 2001, a random access memory (RAM) 2002, a display control unit 2003, a storage device 2004, a data I/F 2005, and a communication I/F 2006. In this manner, a configuration of a general computer can be applied to the learning device 20.

The storage device 2004 is a nonvolatile storage medium such as a hard disk drive or a flash memory. The CPU 2000 controls an entire operation of the learning device 20 by using the RAM 2002 as a work memory according to a program stored in the ROM 2001 and the storage device 2004.

The display control unit 2003 generates a display signal that can be handled by a display apparatus 2020 on the basis of display control information delivered from the CPU 2000, and delivers the display signal to the display apparatus 2020. The display apparatus 2020 includes, for example, a display device such as a liquid crystal display (LCD) and a drive circuit for driving the display device. The display apparatus 2020 displays an image on the display device according to the display signal delivered from the display control unit 2003.

The data I/F 2005 is an interface for transmitting and receiving data between the learning device 20 and an external device. In addition, an input device 2021 that receives a user operation may be connected to the data I/F 2005. A type of the input device 2021 is not particularly limited, but for example, a pointing device such as a mouse or a keyboard can be applied. The UI unit 202 described above may implement a user interface by displaying an image on the input device 2021 and the display apparatus 2020.

The communication I/F 2006 controls communication with the outside of the learning device 20. For example, the communication I/F 2006 controls communication with respect to the network 2. The communication I/F 2006 may directly communicate with the imaging device 10 by wireless communication or the like.

In the learning device 20, the CPU 2000 executes a program for implementing the function according to the embodiment, thereby configuring each of the learning unit 200, the image accumulation unit 201, the UI unit 202, and the display unit 203 described above on a main storage area in the RAM 2002, for example, as a module.

The program can be acquired from the outside via, for example, the network 2 by, for example, communication via the communication I/F 2006 and installed on the learning device 20. Not limited to this, the program may be provided by being stored in a detachable storage medium such as a compact disk (CD), a digital versatile disk (DVD), or a universal serial bus (USB) memory.

### 1-3. Processing According to Embodiment

Next, processing according to the embodiment will be described.

### 1-3-1. Learning Processing According to Embodiment

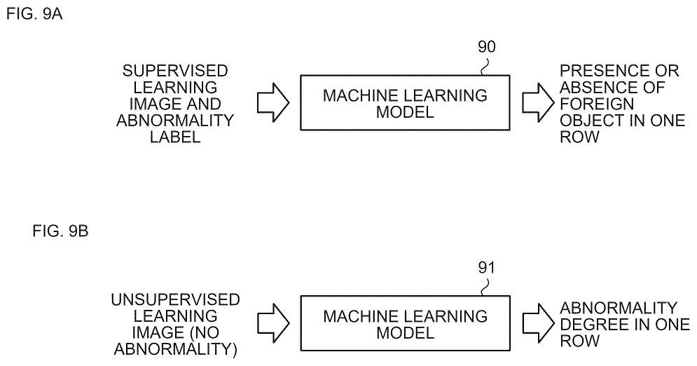

First, learning processing according to the embodiment will be described. FIG. 9 is a schematic diagram for schematically describing learning processing according to the embodiment. In the embodiment, as a machine learning model used for inference of presence or absence of abnormality, both a machine learning model 90 constructed by supervised learning illustrated in Section (a) of FIG. 9 and a machine learning model 91 constructed by unsupervised learning illustrated in Section (b) of FIG. 9 are applicable.

More specifically, the machine learning model 90 illustrated in Section (a) of FIG. 9 is constructed by supervised learning using an image (a line image) to which an abnormality label indicating presence or absence of a foreign object is attached as teacher data. By inputting line image data of the row rₙ designated in the captured image captured by the sensor unit 100 to the machine learning model 90, presence or absence of a foreign object in the row rₙ is inferred.

On the other hand, the machine learning model 91 illustrated in Section (b) of FIG. 9 is constructed by unsupervised learning using an image (a line image) not including a foreign object as learning data. By inputting the line image data of the row rₙ designated in the captured image captured by the sensor unit 100 to the machine learning model 91, an abnormality degree in the row rₙ is inferred. The abnormality degree indicates, for example, a degree to which a foreign object is included in the row rₙ.

### (About Supervised Learning)

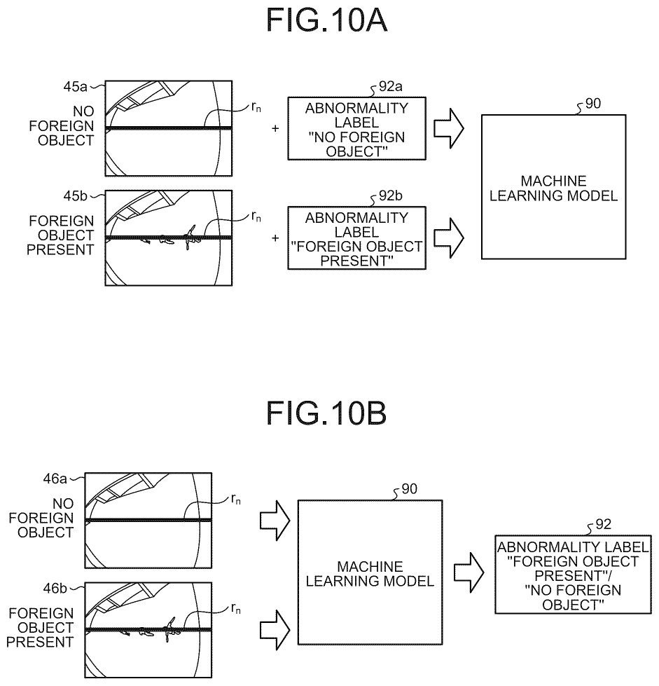

FIGS. 10A and 10B are schematic diagrams for more specifically explaining processing by supervised learning according to the embodiment.

FIG. 10A is a schematic diagram for explaining construction processing of the machine learning model 90 by supervised learning. For example, data obtained by adding an abnormality label 92a indicating “no foreign object” to an image 45a including no foreign object (in this example, a person) in a line image of a designated row rₙ and data obtained by adding an abnormality label 92b indicating “foreign object present” to an image 45b including a foreign object in the line image of the row rₙ are prepared as teacher data. In the learning device 20, the learning unit 200 inputs each prepared teacher data to the machine learning model 90 and causes the machine learning model 90 to learn. The learned machine learning model 90 is transmitted from the learning device 20 to the imaging device 10 and stored in the parameter memory 151 in the inference processing unit 140 of the imaging device 10.

FIG. 10B is a schematic diagram for explaining inference processing by the machine learning model 90 by supervised learning. For example, in the inference processing unit 140 of the imaging device 10, the first processing unit 142 reads the machine learning model 90 stored in the parameter memory 151.

For example, the first processing unit 142 inputs line image data of the row rₙ stored in the line memory 150 in an image 46a not including a foreign object in the designated row rₙ to the machine learning model 90 to perform inference processing, and acquires an abnormality label 92 indicating “no foreign object”. Furthermore, for example, the first processing unit 142 inputs line image data of the row rₙ stored in the line memory 150 in an image 46b including a foreign object in the designated row rₙ to the machine learning model 90 to perform inference processing, and acquires the abnormality label 92 indicating that “foreign object present”

### (About Unsupervised Learning)

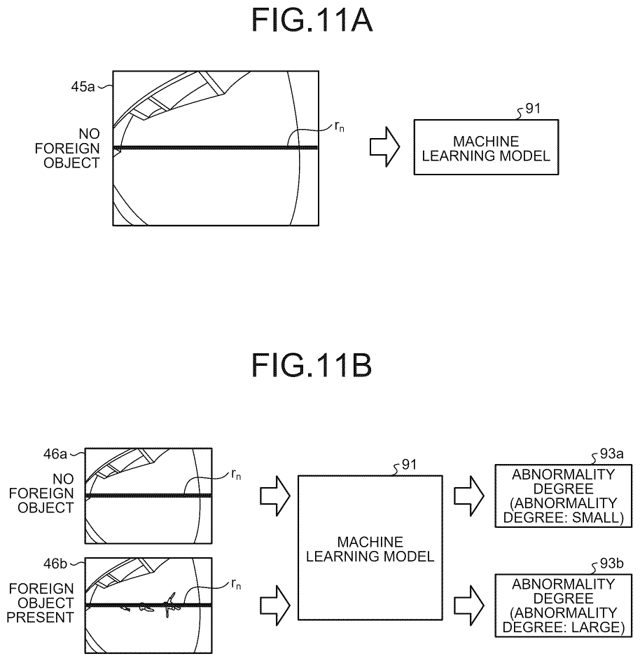

FIGS. 11A and 11B are schematic diagrams for more specifically describing processing by unsupervised learning according to the embodiment.

FIG. 11A is a schematic diagram for explaining construction processing of the machine learning model 91 by unsupervised learning. For example, the image 45a in which no foreign object (a person in this example) is included in the line image of the designated row rₙ is prepared as learning data. In the learning device 20, the learning unit 200 inputs the prepared teacher data to the machine learning model 91 and causes the machine learning model 91 to learn. The learned machine learning model 91 is transmitted from the learning device 20 to the imaging device 10 and stored in the parameter memory 151 in the inference processing unit 140 of the imaging device 10.

FIG. 11B is a schematic diagram for explaining inference processing by the machine learning model 91 by unsupervised learning. For example, in the inference processing unit 140 of the imaging device 10, the first processing unit 142 reads the machine learning model 91 stored in the parameter memory 151.

For example, the first processing unit 142 inputs the line image data of the row rₙ stored in the line memory 150 in the image 46a not including the foreign object in the designated row rₙ to the machine learning model 91 to perform inference processing, and calculates an abnormality degree 93a indicating a small value (for example, a value equal to or less than a threshold). Furthermore, for example, the first processing unit 142 inputs the line image data of the row rₙ stored in the line memory 150 in the image 46b including the foreign object in the designated row rₙ to the machine learning model 91 to perform inference processing, and calculates an abnormality degree 93b indicating a large value (for example, a value exceeding the threshold).

Note that the threshold for determining the abnormality degree may be set by machine learning by the learning unit 200, or may be set by a user operation on the learning device 20, for example.

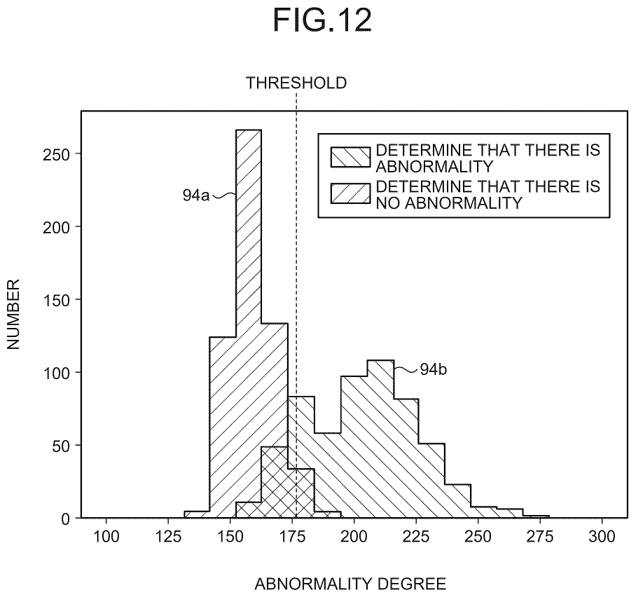

FIG. 12 is a schematic diagram for explaining determination based on the abnormality degree calculated by the machine learning model 91 by the unsupervised learning described with reference to FIG. 11B. In FIG. 12, the horizontal axis represents the abnormality degree, and the vertical axis represents the number of abnormality degrees indicated by the horizontal axis calculated for certain data.

In an example of FIG. 12, magnitude of the abnormality degree is determined on the basis of a distribution 94a or 94b of the abnormality degree calculated for certain data. The distribution 94a illustrates an example of the distribution of the abnormality degree calculated on the basis of the line image data of the row rₙ without the foreign object designated in the image 46a in FIG. 11B. In addition, the distribution 94b illustrates an example of the distribution of the abnormality degree calculated on the basis of the line image data of the row rₙ with the foreign object designated in the image 46b in FIG. 11B.

For example, the first processing unit 142 may obtain a representative value (a maximum value, a median value, an average value, etc.) of the abnormality degree in the distribution 94a or the distribution 94b, compare the obtained representative value with a threshold, and determine the magnitude of the abnormality degree. In the example of FIG. 12, the first processing unit 142 determines an abnormality degree corresponding to the distribution 94a whose representative value is equal to or less than the threshold as the small abnormality degree 93a. On the other hand, the first processing unit 142 determines an abnormality degree corresponding to the distribution 94b whose representative value exceeds the threshold as the large abnormality degree 93b.

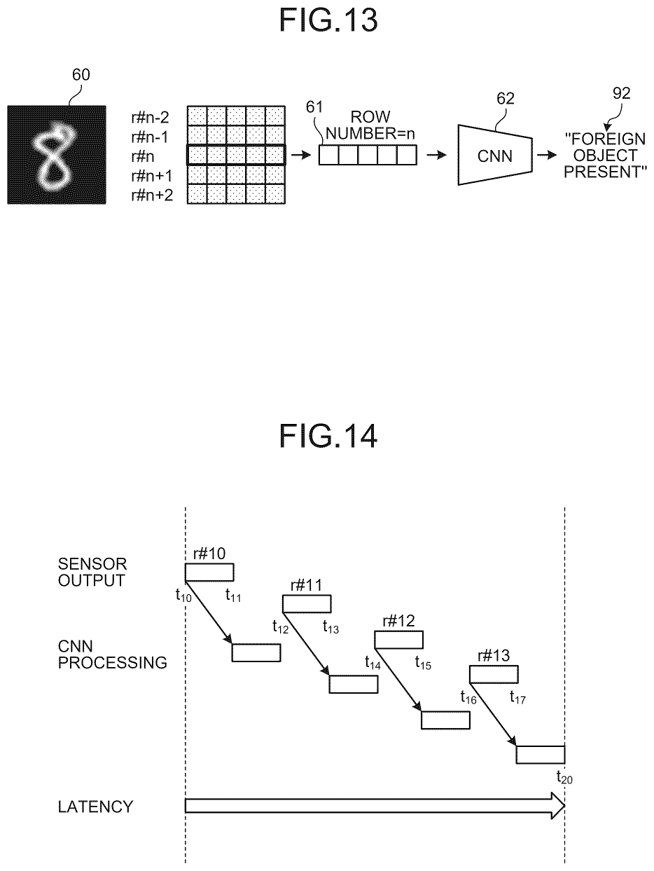

FIG. 13 is a schematic diagram for explaining inference processing by the first processing unit 142 according to the embodiment. In the embodiment, the first processing unit 142 uses a machine learning model by a convolutional neural network (CNN) 62 to infer presence or absence of a foreign object in the line image data of the designated row rₙ. Here, description will be given assuming that the CNN 62 is a network based on the machine learning model 90 constructed by the supervised learning described in Section (a) of FIG. 9.

In FIG. 13, an image 60 including rows r #n−2, r #n−1, r #n, r #n+1, and r #n+2 is considered. The first processing unit 142 reads line image data of a line image 61 of the row r #n, which is a row number n, designated as an inference target and included in the image 60 from the line memory 150. The first processing unit 142 inputs the read line image data of the line image 61 and the row number n of the line image 61 to the CNN 62. The CNN 62 performs one-dimensional convolution processing on the input line image data of the line image 61. In accordance with a result of the convolution processing, the CNN 62 outputs, for example, the abnormality label 92 indicating that “foreign object present” as a result of analogy with the row r #n that is the row number n.

As described above, in the embodiment, the inference processing unit 140 causes the first processing unit 142 to infer the presence or absence of a foreign object on the basis of a horizontal one-dimensional spatial feature amount in the image 60, for example. The inference processing unit 140 outputs an inference result when the inference processing is executed on line images of all rows rₙ designated as inference targets in the image 60.

Furthermore, since the inference processing unit 140 executes the inference processing for each row rₙ designated in the image 60, it can be said that pixel distribution information in a vertical direction of the image 60 is also used for the inference processing. That is, in a case where the image 60 has different spatial feature amounts according to a position in the vertical direction, for example, in a case where an upper half of the image 60 is empty and a lower half thereof is the ground, meaning of a predetermined pixel value differs depending on whether the pixel value is applied to an empty portion or a ground portion. This means that the pixel distribution information in the vertical direction of the image 60 is used.

In the embodiment, after reading the line image data of the line of the designated row rₙ, the first processing unit 142 inputs the row number n of the line and the image data of a reading unit (described later) in the line to the machine learning model (the CNN 62 in this example). On the basis of the input image data of the reading unit and the row number n, the first processing unit 142 uses horizontal space information in the line of the row number n and uses the pixel distribution information in the vertical direction with respect to the line to perform inference processing for each row and output an inference result.

FIG. 14 is a sequence diagram of an example for explaining time-series transition of processing in the first processing unit 142 according to the embodiment. Here, a description will be given assuming that intermittent rows r #10, r #11, r #12, and r #13 are designated with respect to a captured image captured by the sensor unit 100.

The sensor unit 100 reads the row r #10 from time t₁₀ to time t₁₁, and stores line image data of the row r #10 in the line memory 150. The first processing unit 142 reads the line image data of the row r #10 from the line memory 150 at time t₁₁, for example, and executes inference processing by the CNN 62. An inference result of the inference processing by the CNN 62 is stored in the data accumulation unit 130 via the output control unit 105, for example, in association with a row number rₙ of the row r #10. The inference result may be represented by information in which presence or absence of a foreign object is indicated by a value “0” or a value “1” for each row, for example.

Next, the sensor unit 100 reads the row r #11 from time t₁₂ to time t₁₃, and stores line image data of the row r #11 in the line memory 150. The first processing unit 142 reads the line image data of the row r #10 from the line memory 150 at time t₁₃, for example, and executes inference processing by the CNN 62.

Thereafter, similarly, the sensor unit 100 reads the row r #12 from time t₁₄ to time t₁₅, and the first processing unit 142 executes inference processing by the CNN 62 from time t₁₅ and outputs an inference result. Furthermore, the sensor unit 100 reads the row r #13 from time t₁₆ to time t₁₇, and the first processing unit 142 executes inference processing by the CNN 62 from time t₁₇ and outputs an inference result.

Latency of the inference processing for the captured image captured by the sensor unit 100 is a time from time t₁₀ when reading of the line image data of the first designated row r #10 by the sensor unit 100 is started to time t₂₀ when the inference processing by the first processing unit 142 for the last designated row r #13 is completed. In the embodiment, since the inference processing is executed only on the line image data of the row designated for the captured image, for example, the latency can be reduced as compared with a case where the inference processing is performed using the line image data of all the rows included in the captured image.

Note that FIG. 14 illustrates that the inference processing by the CNN 62 in the first processing unit 142 is executed after reading of one line image data by the sensor unit 100 is completed, but this is not limited to this example. For example, the sensor unit 100 may read next line image data during execution of the inference processing by the first processing unit 142. By doing so, the latency of the inference processing can be further reduced.

As described above, in the embodiment, the inference processing by the first processing unit 142 is executed for each row read by the sensor unit 100. Therefore, a calculation time required for the inference processing can be made substantially constant for each row, and a capacity of a memory holding a calculation process can be suppressed.

### (Input/Output Unit of Data in Machine Learning Model)

Next, an input/output unit of data in the machine learning model in the first processing unit 142 applicable to the embodiment will be described.

FIG. 15 is a schematic diagram for describing an input unit of image data to be input to the machine learning model applicable to the embodiment. Section (a) of FIG. 15 is an example in which an entire image 83 of one row designated in an image 82 is set as an input unit of the machine learning model. In this case, the first processing unit 142 inputs any one of the following four ways (1) to (4) to the machine learning model.
(1) The image 83 only;
(2) the image 83 and a row number corresponding to the image 83;
(3) the image 83 and a column number corresponding to the image 83; and
(4) the image 83 and the row number and the column number corresponding to the image 83.

Among them, in (3) and (4), column numbers of one end and another end columns of a range to be noted in the image 83 may be applied to the column number.

Section (b) of FIG. 15 is an example in which an image 84 in a partial range of one row designated in the image 82 is set as an input unit of the machine learning model. In this case, the first processing unit 142 inputs any one of the following four ways (5) to (8) to the machine learning model.
(5) The image 84 only;
(6) the image 84 and a row number corresponding to the image 84;
(7) the image 84 and a column number corresponding to the image 84; and
(8) the image 84 and the row number and the column number corresponding to the image 84.

Among them, in (7) and (8), a column number indicating a column c #m−1 of one end column and a column number indicating a column c #m+1 of another end column of a range corresponding to the image 84 in the row including the image 84 may be applied to the column number.

Note that, in Sections (a) and (b) of FIG. 15, by including the row number and the column number in the data input to the machine learning model as in (3), (4), (7), and (8) described above, it is possible to determine whether or not a pixel value in the range indicated by the row number and the column number is normal. As an example, in a case where the range is a range in which “forest” is imaged, it can be determined that the range is normal if a pixel value indicates “green”, and it can be determined that the range is not normal if the pixel value indicates a color other than “green” (human skin color or the like). In a case where the range is not normal, it can be inferred that there is a foreign object.

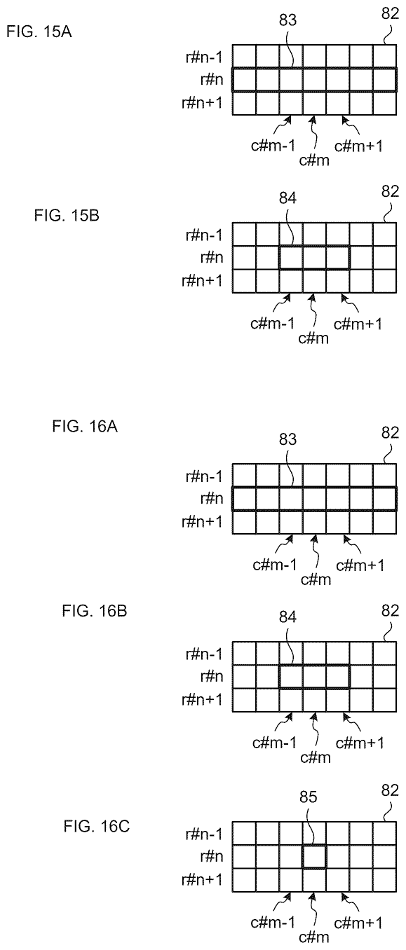

FIG. 16 is a schematic diagram for explaining an output unit of image data output from the machine learning model applicable to the embodiment. Section (a) of FIG. 16 is an example in which the entire image 83 of one row designated in the image 82 is set as an output unit of an inference result. Section (b) is an example in which the image 84 in the partial range of one row designated in the image 82 (in this example, the range of columns c #m−1 to c #m+1 in the row r #n) is set as an output unit of an inference result. Furthermore, Section (c) is an example in which one specific pixel 85 of one row designated in the image 82 (in this example, a column c #m in the row r #n) is set as an output unit of an inference result.

Note that, in any example of Sections (a) to (c) of FIG. 16, in a case where the machine learning model 90 by supervised learning is used as the machine learning model, “foreign object present” or “no foreign object” is output as the inference result for each output unit. On the other hand, in a case where the machine learning model 90 by supervised learning is used as the machine learning model, “abnormality degree” is output as the inference result for each output unit.

### 1-3-2. Details of Inference Processing According to Embodiment

Next, the inference processing according to the embodiment will be described in more detail.

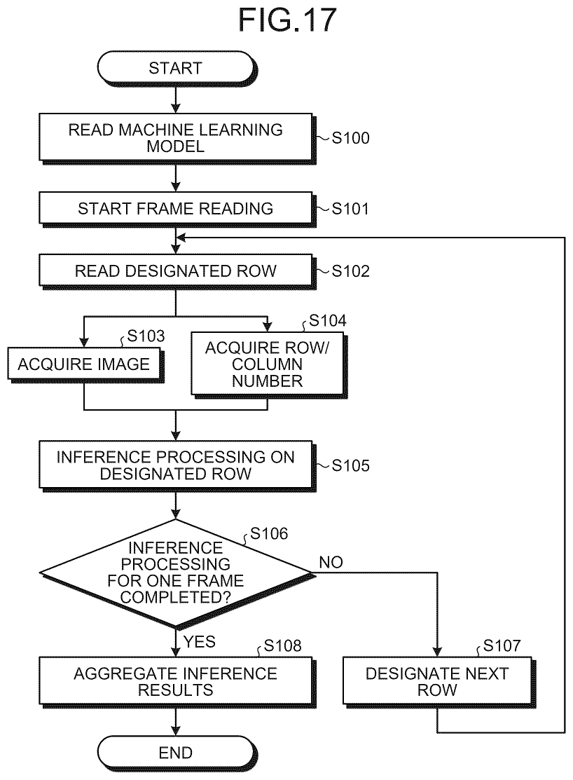

FIG. 17 is a flowchart illustrating an example of inference processing by the inference processing unit 140 according to the embodiment. Note that, prior to the processing according to the flowchart of FIG. 17, it is assumed that one or more rows r #n to be inferred are intermittently designated for each row in a frame image, and information indicating each designated row r #n is written in the register 107.

In FIG. 17, in step S100, the inference processing unit 140 reads a machine learning model from the parameter memory 151. In the next step S101, the sensor control unit 101 starts reading of a frame by the sensor unit 100. In the next step S102, the sensor control unit 101 reads line image data of a row indicated by the row r #n designated as an analogy processing target from the frame, and stores the line image data in the line memory 150. In addition, the sensor control unit 101 stores a row number indicating a row of the read line image data in the line memory 150 together with the line image data.

Note that, when a column number is designated together with the row number as the inference processing target, the sensor control unit 101 stores the designated column number in the line memory 150 together with the line image data and the row number.

In the next step S103, the inference processing unit 140 acquires the line image data from the line memory 150 by the first processing unit 142. Further, in step S104 that can be executed in parallel with step S103, the inference processing unit 140 causes the first processing unit 142 to acquire the row number from the line memory 150. In a case where the column number is further designated, the inference processing unit 140 acquires the column number together with the row number in step S104.

After the processing of steps S103 and S104, the processing proceeds to step S105.

In step S105, the first processing unit 142 executes inference processing by the machine learning model on the line image data of the designated row. More specifically, the first processing unit 142 inputs the row number acquired in step S104 and the line image data acquired in step S103 to the machine learning model, and executes the inference processing. The first processing unit 142 causes the data accumulation unit 130 to store an inference result for the line image data of the row indicated by the row number together with the row number.

In the next step S106, the inference processing unit 140 determines whether or not inference processing for one frame from which reading is started in step S101 has been completed. In a case where the inference processing unit 140 determines that the inference processing for one frame has not been completed (Step S106, “No”), the processing proceeds to step S107 and designates a next inference target row r #n+1. After the processing of step S107, the processing proceeds to step S102.

On the other hand, when the inference processing unit 140 determines that the inference processing for one frame has been completed in step S106 (Step S106, “Yes”), the processing proceeds to step S108. In step S108, the inference processing unit 140 causes the second processing unit 143 to read the inference result of each row stored in the data accumulation unit 130 in step S105 and aggregate the read inference results. When the processing of step S108 is completed, a series of processes according to the flowchart of FIG. 17 is ended.

Aggregation processing of the inference results by the second processing unit 143 in step S108 in the flowchart of FIG. 17 will be described more specifically.

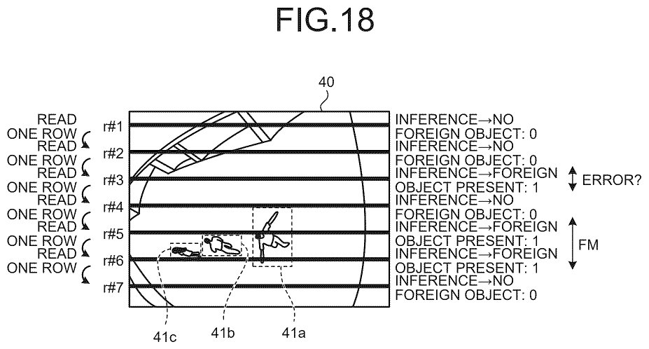

FIG. 18 is a schematic diagram illustrating an example of inference results before execution of the aggregation processing by the second processing unit 143 according to the embodiment. In the example of FIG. 18, rows r #1 to r #7 are designated as inference processing targets for the captured image 40. The first processing unit 142 executes inference processing on each of the rows r #1 to r #7 by the machine learning model and acquires an inference result. In the example of FIG. 18, “no foreign object” is acquired as the inference results for the rows r #1, r #2, r #4, and r #7. On the other hand, “foreign object present” is acquired as the inference results for the rows #3, r #5, and r #6.

Among these inference results, for the rows r #5 and r #6, since the inference result of “foreign object present” is acquired in a certain range FM, it can be determined that there is a high possibility that a foreign object is present in the range FM in the captured image 40. On the other hand, for the row r #3, since the inference result of “foreign object present” is acquired in the isolated row r #3, it can be determined that the inference result is noise and there is a possibility of erroneous detection (ERROR).

In the embodiment, a position of the foreign object is determined on the basis of the inference result of each row r #n in a set of the plurality of rows continuously designated, thereby suppressing the erroneous detection. For example, a moving average may be applied to a determination result of each row r #n included in the set. The moving average is a method of setting a window of an arbitrary number of samples for a plurality of aligned samples and obtaining an average value of values of the samples included in the window while moving the window in an alignment direction of the plurality of samples. By using the moving average, it is possible to suppress an influence of noise in a plurality of samples.

As an example, the inference result of “no foreign object” is represented by a value “0”, the inference result of “foreign object present” is represented by a value “1”, and among a plurality of rows r #n designated as the inference processing targets in the image, a moving average value is calculated using any number of rows r #n−k, . . . , r #n, . . . , r #n+k continuously designated as a window. The calculated moving average value is compared with a threshold, and when the moving average value exceeds the threshold, a representative row (for example, the row r #n) among the rows r #n−k, . . . , r #n, . . . , r #n+k included in the window is determined as “foreign object present”. When the calculated moving average value is equal to or less than the threshold, a representative row among the rows r #n−k, . . . , r #n, . . . , and r #n+k included in the window is determined as “no foreign object”. The moving average is calculated for each window while shifting the window, and the position of the foreign object in the image is determined.

Note that, when the number of rows included in the window for calculating the moving average is an odd number, the center row r #n among the plurality of rows r #n-k, . . . , r #n, . . . , r #n+k can be selected as a representative row, which is preferable.

Further, a shift of about several pixels due to wind, vibration, shaking of the background, or the like in the line image data of the designated row r #n is learned as “background”, and can be inferred as “no foreign object”.

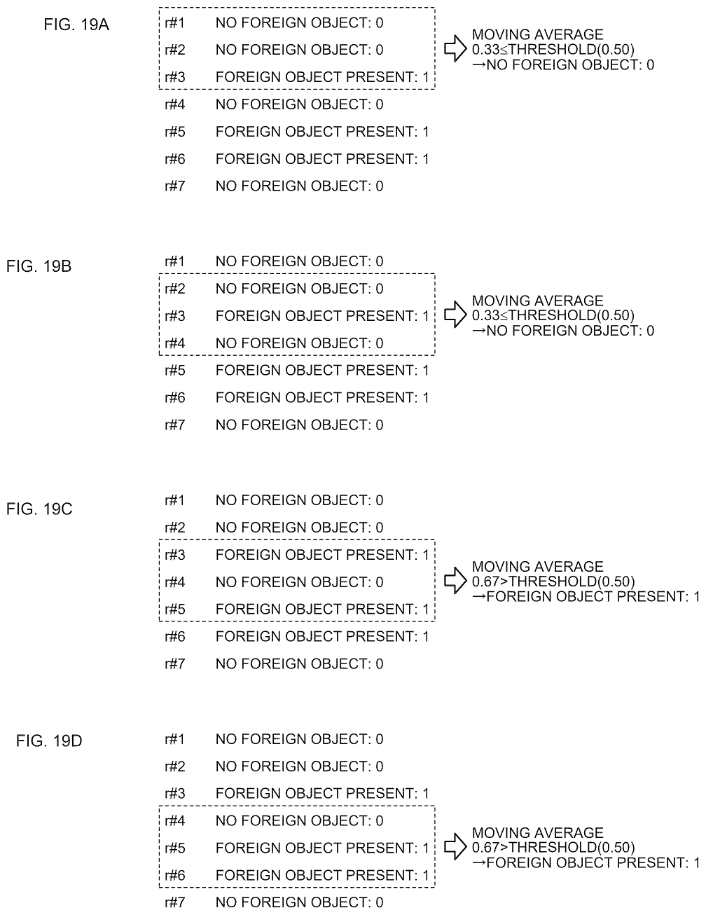

FIG. 19 is a schematic diagram for more specifically explaining moving average calculation processing of an inference result according to the embodiment. In FIG. 19, the number of samples (the number of rows) of a window is set to “3”, and a threshold for determining presence/absence of a foreign object is set to “0.50”.

In Sections (a) to (d) of FIG. 19, rows r #1 to r #7 correspond to the rows r #1 to r #7 of FIG. 18, respectively. Here, a window including three consecutively designated rows r #n−1, r #n, and r #n+1 is set for each row r #1 to r #7, and a moving average is calculated on the basis of each row r #n−1, r #n, and r #n+1 included in the window.

In Section (a) of FIG. 19, a moving average is calculated for a window including the rows r #1, r #2, and r #3. In the rows r #1 and r #2, the inference result is “no foreign object”, and the value is “0”. In the row r #3, the inference result is “foreign object present”, and the value is “1”. The moving average of the inference results of the rows r #1, r #2, and r #3 is a value “0.33” and is equal to or less than the threshold. Therefore, the second processing unit 143 determines that there is a low possibility that a foreign object exists in a range of the rows r #1, r #2, and r #3.

In Section (b) of FIG. 19, the window is shifted by one row from Section (a), and a moving average is calculated for the window including the rows r #2, r #3, and r #4. In the rows r #2 and r #4, the inference result is “no foreign object”, and the value is “0”. In the row r #3, the inference result is “foreign object present”, and the value is “1”. The moving average of the inference results of the rows r #2, r #3, and r #4 is a value “0.33” and is equal to or less than the threshold. Therefore, the second processing unit 143 determines that there is a low possibility that a foreign object exists in a range of the rows r #2, r #3, and r #4.

In Section (c) of FIG. 19, the window is shifted by one row from Section (b), and a moving average is calculated for the window including the rows r #3, r #4, and r #5. In the rows r #2 and r #4, the inference result is “no foreign object”, and the value is “0”. In the row r #3, the inference result is “foreign object present”, and the value is “1”. The moving average of the inference results of the rows r #2, r #3, and r #4 is a value “0.67”, which exceeds the threshold. Therefore, the second processing unit 143 determines that there is a high possibility that a foreign object exists in a range of the rows r #2, r #3, and r #4.

In Section (d) of FIG. 19, the window is shifted by one row from Section (c), and a moving average is calculated for the window including the rows r #4, r #5, and r #6. In the row r #4, the inference result is “no foreign object”, and the value is “0”. In the rows r #5 and r #6, the inference result is “foreign object present”, and the value is “1”. The moving average of the inference results of the rows r #4, r #5, and r #6 is a value “0.67”, which exceeds the threshold. Therefore, the second processing unit 143 determines that there is a high possibility that a foreign object exists in a range of the rows r #4, r #5, and r #6.

In addition, although not illustrated, in the window including the rows r #5, r #6, and r #7 in which the window is shifted by one row from Section (d), the inference result in the rows r #5 and r #6 is “foreign object present” and the value is “1”, and the inference result in the row r #7 is “no foreign object” and the value is “0”. The moving average of the inference results of the rows r #5, r #6, and r #7 is a value “0.67”, which exceeds the threshold. Therefore, the second processing unit 143 determines that there is a high possibility that a foreign object exists in a range of the rows r #5, r #6, and r #7.

The second processing unit 143 may aggregate these determination results and determine a position of the foreign object in the captured image 40. For example, the second processing unit 143 may determine that, in the range of the rows r #1 to r #4 in which it is determined that the possibility that the foreign object exists is low, the inference result of “foreign object present” in the row r #3 is noise and there is no foreign object. In addition, for example, the second processing unit 143 may determine that, in the rows r #3 to r #7 in which it is determined that the possibility that the foreign object exists is high, a foreign object exists in the range of the rows r #5 and r #6 in which the inference result of “foreign object present” is redundantly obtained.

The second processing unit 143 acquires the inference results of the rows r #1 to r #7 by the first processing unit 142 from the data accumulation unit 130. The second processing unit 143 calculates the moving average described with reference to FIG. 19 on the basis of the inference results of the rows r #1 to r #7 acquired from the data accumulation unit 130, and aggregates the inference results of the rows r #1 to r #7. The second processing unit 143 may store the aggregated inference result in the data accumulation unit 130.

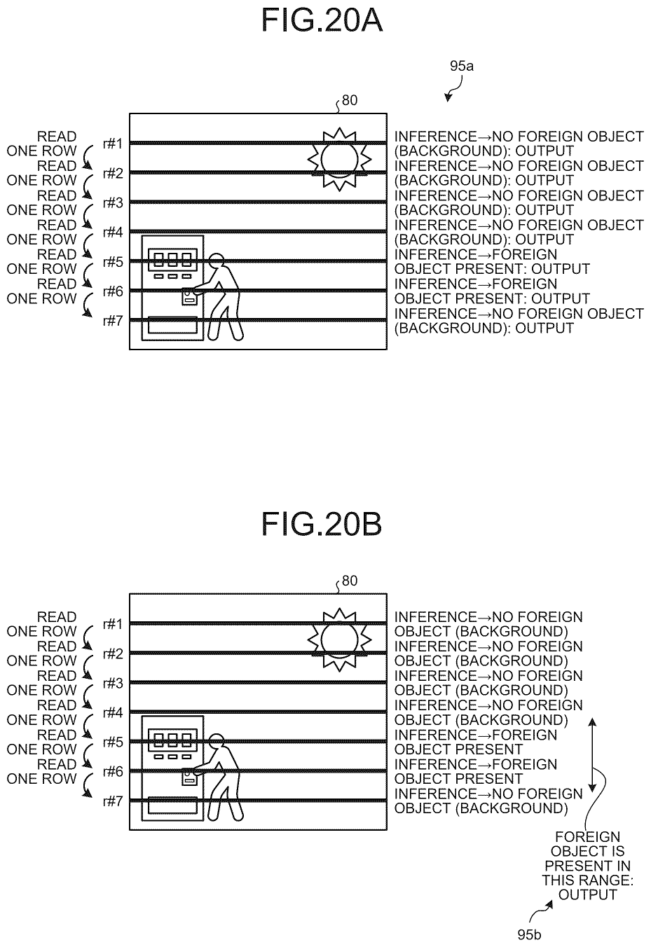

An inference result aggregation method according to the embodiment will be described. FIGS. 20A and 20B are schematic diagrams for explaining an inference result aggregation method according to the embodiment. In FIGS. 20A and 20B, inference results of rows r #1 to r #7 designated for a captured image 80 are that the rows r #1 to r #4 and r #7 are “no foreign object” and the rows r #5 and r #6 are “foreign object present”. Note that a line image of a row inferred as “no foreign object” is assumed to be a background image.

FIG. 20A is an example in which the inference results of the rows r #1 to r #7 designated for the captured image 80 are not aggregated and are output for each of the rows r #1 to r #7. In the example of FIG. 20A, an output 95a of the inference processing unit 140 includes information on “no foreign object” and “foreign object present” for each of the rows r #1 to r #7. This output 95a is output from the first processing unit 142, for example. In a case where the output 95a illustrated in FIG. 20A is applied, for example, the processing of step S108 in the flowchart of FIG. 17 can be omitted.

FIG. 20B is an example in which the inference results of the rows r #1 to r #7 designated for the captured image 80 are aggregated and output. In the example of FIG. 20B, an output 95b of the inference processing unit 140 indicates that a foreign object exists in a range related to the rows r #5 and r #6. In the inference processing unit 140, for example, in step S108 in the flowchart of FIG. 17, the second processing unit 143 calculates a moving average described with reference to FIG. 19 on the basis of the inference results of the rows r #1 to r #7 stored in the data accumulation unit 130, and aggregates the inference results of the rows r #1 to r #7.

### 1-3-3. About Setting of Region of Interest

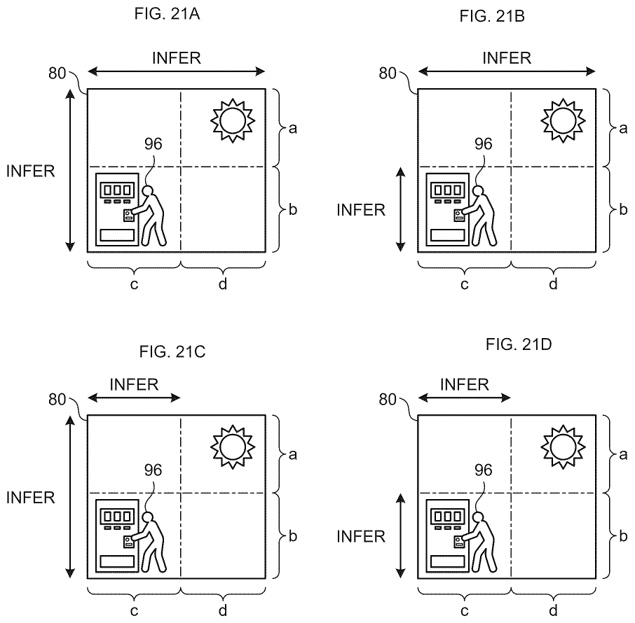

Next, an example in which a region of interest is set for a captured image and the set region of interest is set as an inference range in which inference of “foreign object present” and “no foreign object” is performed according to the embodiment will be described. FIG. 21 is a schematic diagram illustrating an example of setting of a region of interest according to the embodiment.

In Sections (a) to (d) of FIG. 21, a region b where a foreign object 96 (a person in this example) is highly likely to appear and a region a where the foreign object 96 is less likely to appear (the sky in this example) are set in a vertical direction with respect to the captured image 80. Similarly, a region c where the foreign object 96 is highly likely to appear and a region d where the foreign object 96 is less likely to appear are set in a horizontal direction with respect to the captured image 80.

Section (a) of FIG. 21 is an example in which the entire captured image 80, that is, a range of all rows and all columns of the captured image 80 is set as the region of interest. In the example of Section (a), all of the regions a and b set in the vertical direction and the regions c and d set in the horizontal direction are set as the region of interest.

Section (b) of FIG. 21 is an example in which a range including some rows and all columns of the captured image 80 is set as the region of interest. In the example of Section (b), a range in which the region b set in the vertical direction and the regions c and d set in the horizontal direction overlap is set as the region of interest. Note that the region c in the horizontal direction can be set by designating column numbers at both ends of the region c with respect to the captured image 80.

Section (c) of FIG. 21 is an example in which a range including all rows and some columns of the captured image 80 is set as the region of interest. In the example of Section (c), a range in which the regions a and b set in the vertical direction and the region c set in the horizontal direction overlap is set as the region of interest.

Section (d) of FIG. 21 is an example in which a range including some rows and some columns of the captured image 80 is set as the region of interest. In the example of Section (d), a range in which the region b set in the vertical direction and the region c set in the horizontal direction overlap is set as the region of interest.

For example, in an imaging range of the imaging device 10 as a fixed camera with a fixed imaging range, in a case where coordinates of the region of interest where appearance of the foreign object 96 is predicted are known, a row r #n to be an inference processing target with respect to the region of interest is intermittently designated. In the inference processing unit 140, the first processing unit 142 executes the inference processing only within the set region of interest. The first processing unit 142 does not perform inference outside the region of interest in the captured image 80. As illustrated in Sections (b) to (d) of FIG. 21, it is possible to reduce a load related to the inference processing by setting the region of interest indicating the inference range to the captured image 80.

### 1-4. Comparison with Existing Technique

Next, the embodiment of the present disclosure will be described in comparison with an existing technique.

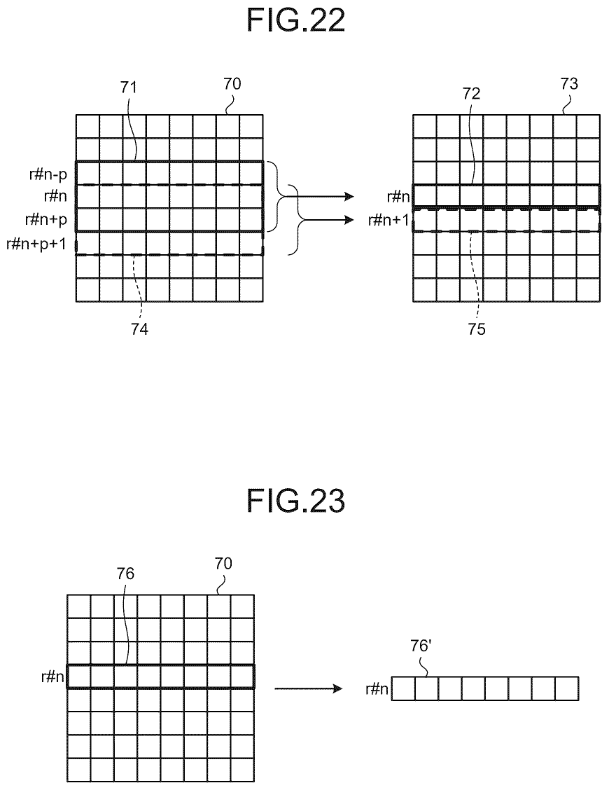

FIG. 22 is a schematic diagram for schematically explaining a technique disclosed in Patent Literature 1 as an existing technique. In Patent Literature 1, in order to output an image 72 of a scanning line r #n of an output image 73, convolution processing is performed on an attention image 71 from a scanning line r #n−p to a scanning line r #n+p of an input image 70, which is a reading unit according to a size of a convolution mask. Similarly, in order to output an image 75 of the next scanning line r #n+1 of the output image 73, the convolution processing is executed on an attention image 74 from the scanning lines r #n to r #n+p+1 of the input image 70, which is a reading unit.

That is, in Patent Literature 1, after the scanning lines are sequentially read from an upper end or a lower end of the attention image, the convolution processing is performed for each reading unit, and image rendering is performed. Therefore, in Patent Literature 1, in order to output an image of one scanning line, images of a plurality of scanning lines included in the reading unit in the input image 70 are stored in a memory.

FIG. 23 is a schematic diagram for explaining a technique according to the embodiment of the present disclosure in comparison with the existing technique. As described above, the imaging device 10 according to the embodiment reads line image data of a line image 76 of a row r #n designated in the input image 70 as a reading unit. The imaging device 10 according to the embodiment outputs an inference result 76′ of presence or absence of a foreign object using the line image data of the line image 76 of the reading unit and a machine learning model learned about a row number, or the row number and a column number of the line image 76.

Therefore, in the embodiment of the present disclosure, a memory used for executing the inference processing only needs to have a capacity capable of storing image data for one line, and a required memory capacity is small with respect to Patent Literature 1. Furthermore, since the inference result 76′ of one line is output on the basis of the line image data of the line image 76 of one line, high-speed processing can be performed with respect to Patent Literature 1.

Further, according to Patent Literature 1, the convolution processing is performed on the basis of line image data of the plurality of rows in the input image 70. Here, in a case where a rolling shutter method in which exposure is sequentially performed from an imaging element is applied to the imaging device as an imaging method, rolling distortion occurs in the output image due to a difference in reading timing of each line. In this case, this rolling distortion may affect the convolution processing.

On the other hand, in the embodiment of the present disclosure, the inference processing using the machine learning model is completed in a single row. Therefore, the inference processing according to the embodiment of the present disclosure can eliminate an influence of the rolling distortion.

### 2. Modification of Embodiment

Next, a modification of the embodiment will be described. In the above-described embodiment, the imaging range of the imaging device 10 is fixed. On the other hand, the modification of the embodiment is an example in which the imaging range of the imaging device 10 is variable.

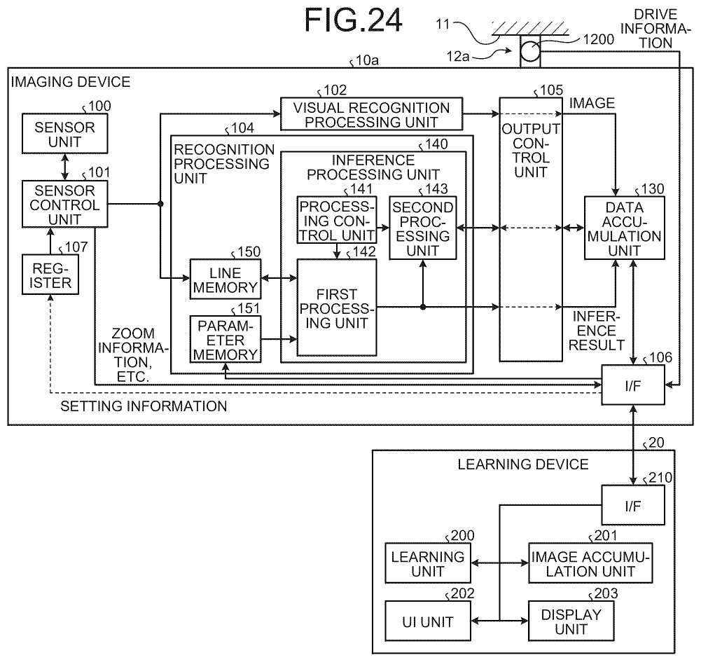

FIG. 24 is a block diagram illustrating a configuration of an example of an imaging device according to the modification of the embodiment. In FIG. 24, an imaging device 10a according to the modification of the embodiment is attached to the fixed object 11 by a fitting 12a, similarly to the imaging device 10 according to the embodiment described with reference to FIGS. 3 and 7. Here, the fitting 12a applied to the modification of the embodiment includes a movable portion 1200 in which an imaging direction and a tilt angle of the imaging device 10a are variable. The imaging range of the imaging device 10a can be changed by changing the imaging direction and the tilt angle of the imaging device 10a with the fitting 12a.

The movable portion 1200 includes, for example, a drive unit using a motor or the like, and can change the imaging direction and the tilt angle by controlling the drive unit. The movable portion 1200 may change the imaging direction and the tilt angle in accordance with control from the outside of the fitting 12a, or may change the imaging direction and the tilt angle in accordance with preset information set in a drive control circuit inside the fitting 12a. For example, the movable portion 1200 may change at least one of the imaging direction and the tilt angle at predetermined time intervals according to the preset information to switch the imaging range of the imaging device 10a.

The movable portion 1200 passes, to the I/F 106, drive information related to changes in the imaging direction and the tilt angle on the basis of a drive control signal.

Furthermore, the imaging device 10a according to the modification of the embodiment can change an imaging condition at the time of imaging according to a predetermined control signal under the control of the sensor control unit 101. The changeable imaging condition includes, for example, zooming by the optical unit 120 (see FIG. 3). In the imaging device 10a, the sensor control unit 101 may change the imaging condition in accordance with control from the outside, or may change the imaging condition in accordance with preset information set for the imaging device 10a. The sensor control unit 101 passes zoom information indicating a zoom state to the I/F 106.

The I/F 106 transmits the drive information transferred from the movable portion 1200 and the zoom information transferred from the sensor control unit 101 to the learning device 20. The learning device 20 receives the drive information and the zoom information transmitted from the imaging device 10a by the I/F 210 and passes the same to the learning unit 200. The learning unit 200 causes a machine learning model to learn by using line image data, a row number/column number, the drive information, and the zoom information transmitted from the imaging device 10a, and transmits the learned machine learning model to the imaging device 10a through the I/F 210.

The imaging device 10a receives, by the I/F 106, the machine learning model learned by using the line image data, the row number/column number, the drive information, and the zoom information transmitted from the learning device 20, and stores the machine learning model in the parameter memory 151. The first processing unit 142 uses the machine learning model stored in the parameter memory 151 to execute inference processing on the line image data stored in the line memory 150. As a result, the imaging device 10a can execute the processing of inferring presence or absence of a foreign object using the imaging direction, the tilt angle, and the zoom information in addition to the line image data and the row number/column number of the line image data.

Note that effects described in the present specification are merely examples and are not limited, and other effects may be provided.

Note that the present technology can also have the following configurations.
(1) An imaging device comprising:
   an imaging unit that has a pixel region in which a plurality of pixels is arranged in a matrix array, and reads and outputs a pixel signal from the pixel included in the pixel region; and
   a first processing unit that infers, on a basis of the pixel signals of the pixels included in designated rows among the pixels included in the pixel region, presence or absence of a foreign object for each of the rows.
(2) The imaging device according to the above (1), wherein
   the first processing unit
   infers the presence or absence of the foreign object for each of the rows by using a model learned using information indicating the designated rows and the pixel signals of the pixels included in the designated rows.
(3) The imaging device according to the above (2), wherein
   the model is a model learned by supervised learning.
(4) The imaging device according to the above (2), wherein
   the model is a model learned by unsupervised learning, and
   the first processing unit
   obtains an abnormality degree for each of the rows by using the model, and infers the presence or absence of the foreign object for each of the rows on a basis of the obtained abnormality degree.
(5) The imaging device according to any one of the above (2) to (4), wherein
   the imaging device is used by being attached to a fixed object by a fitting capable of fixing an imaging range by the imaging unit, and
   the first processing unit
   infers, in a case where the imaging device is used, the presence or absence of the foreign object for each of the rows by using the model learned on a basis of the pixel signals output by the imaging unit of the imaging device attached to the fixed object by the fitting in the used state.
(6) The imaging device according to any one of the above (2) to (4), wherein
   the imaging device is used by being attached to a fixed object by a fitting capable of changing an imaging range by the imaging unit according to control, and
   further comprising:
   the first processing unit
   infers, in a case where the imaging device is used, the presence or absence of the foreign object for each of the rows according to a change of the imaging range by using the model for each change of the imaging range learned on a basis of the pixel signals output for the change of the imaging range by the imaging unit of the imaging device attached by the fitting in the used state.
(7) The imaging device according to any one of the above (2) to (6), wherein
   the first processing unit
   infers, in a case where the imaging device is used under a predetermined imaging condition, the presence or absence of the foreign object for each of the rows by using the model learned in advance on a basis of the pixel signals output by the imaging unit on a basis of the predetermined imaging condition.
(8) The imaging device according to any one of the above (1) to (7), wherein
   the first processing unit
   infers the presence or absence of the foreign object for each of the rows intermittently designated with respect to the pixel region.
(9) The imaging device according to the above (8), further comprising
   a second processing unit that sets a window including three or more rows arranged consecutively with respect to the rows intermittently designated with respect to the pixel region, and determines a position of the foreign object on a basis of each inference result in which the presence or absence of the foreign object has been inferred by the first processing unit for each of the rows included in the window.
(10) The imaging device according to the above (9), wherein
   the second processing unit
   determines the position of the foreign object on a basis of a moving average of the inference results for each of the rows included in the window.
(11) The imaging device according to any one of the above (1) to (10), wherein
   the first processing unit
   infers the presence or absence of the foreign object for each of the rows intermittently designated in a region of interest set for the pixel region.
(12) The imaging device according to any one of the above (1) to (11), wherein
   the first processing unit
   infers the presence or absence of the foreign object for each of the rows on a basis of the pixel signals of the pixels included in columns further designated in the designated rows among the pixels included in the pixel region.
(13) The imaging device according to the above (12), wherein
   the first processing unit
   infers the presence or absence of the foreign object in a region designated by the designated rows and the designated columns.
(14) An imaging method executed by a processor, comprising:
   an imaging step of reading and outputting, by an imaging unit including a pixel region in which a plurality of pixels is arranged in a matrix array, a pixel signal from the pixel included in the pixel region; and
   a first processing step of inferring, on a basis of the pixel signals of the pixels included in designated rows among the pixels included in the pixel region, presence or absence of a foreign object for each of the rows.
(15) An imaging program for causing a processor to execute:
   an imaging step of reading and outputting, by an imaging unit including a pixel region in which a plurality of pixels is arranged in a matrix array, a pixel signal from the pixel included in the pixel region; and
   a first processing step of inferring, on a basis of the pixel signals of the pixels included in designated rows among the pixels included in the pixel region, presence or absence of a foreign object for each of the rows.

### REFERENCE SIGNS LIST

1 MONITORING SYSTEM
10, 10a IMAGING DEVICE
11 FIXED OBJECT
12, 12a FITTING
20 LEARNING DEVICE
62 CNN
90, 91 MACHINE LEARNING MODEL
92, 92a, 92b ABNORMALITY LABEL
93a, 93b ABNORMALITY DEGREE
94a, 94b DISTRIBUTION
95a, 95b OUTPUT
96 FOREIGN OBJECT
100 SENSOR UNIT
101 SENSOR CONTROL UNIT
102 VISUAL RECOGNITION PROCESSING UNIT
104 RECOGNITION PROCESSING UNIT
105 OUTPUT CONTROL UNIT
106, 210 I/F
107 REGISTER
130 DATA ACCUMULATION UNIT
140 INFERENCE PROCESSING UNIT
141 PROCESSING CONTROL UNIT
142 FIRST PROCESSING UNIT
143 SECOND PROCESSING UNIT
150 LINE MEMORY
151 PARAMETER MEMORY
200 LEARNING UNIT
201 IMAGE ACCUMULATION UNIT
202 UI UNIT
203 DISPLAY UNIT
1000 PIXEL CIRCUIT
1001 PIXEL ARRAY UNIT
1002 VERTICAL SCANNING UNIT
1100 CONTROL UNIT
1200 MOVABLE PORTION

1. An imaging device comprising:
an imaging unit that has a pixel region in which a plurality of pixels is arranged in a matrix array, and reads and outputs a pixel signal from the pixel included in the pixel region; and
a first processing unit that infers, on a basis of the pixel signals of the pixels included in designated rows among the pixels included in the pixel region, presence or absence of a foreign object for each of the rows.

2. The imaging device according to claim 1, wherein
the first processing unit
infers the presence or absence of the foreign object for each of the rows by using a model learned using information indicating the designated rows and the pixel signals of the pixels included in the designated rows.

3. The imaging device according to claim 2, wherein
the model is a model learned by supervised learning.

4. The imaging device according to claim 2, wherein
the model is a model learned by unsupervised learning, and
the first processing unit
obtains an abnormality degree for each of the rows by using the model, and infers the presence or absence of the foreign object for each of the rows on a basis of the obtained abnormality degree.

5. The imaging device according to claim 2, wherein
the imaging device is used by being attached to a fixed object by a fitting capable of fixing an imaging range by the imaging unit, and
the first processing unit
infers, in a case where the imaging device is used, the presence or absence of the foreign object for each of the rows by using the model learned on a basis of the pixel signals output by the imaging unit of the imaging device attached to the fixed object by the fitting in the used state.

6. The imaging device according to claim 2, wherein
the imaging device is used by being attached to a fixed object by a fitting capable of changing an imaging range by the imaging unit according to control, and
further comprising:
the first processing unit
infers, in a case where the imaging device is used, the presence or absence of the foreign object for each of the rows according to a change of the imaging range by using the model for each change of the imaging range learned on a basis of the pixel signals output for the change of the imaging range by the imaging unit of the imaging device attached by the fitting in the used state.

7. The imaging device according to claim 2, wherein
the first processing unit
infers, in a case where the imaging device is used under a predetermined imaging condition, the presence or absence of the foreign object for each of the rows by using the model learned in advance on a basis of the pixel signals output by the imaging unit on a basis of the predetermined imaging condition.

8. The imaging device according to claim 1, wherein
the first processing unit
infers the presence or absence of the foreign object for each of the rows intermittently designated with respect to the pixel region.

9. The imaging device according to claim 8, further comprising
a second processing unit that sets a window including three or more rows arranged consecutively with respect to the rows intermittently designated with respect to the pixel region, and determines a position of the foreign object on a basis of each inference result in which the presence or absence of the foreign object has been inferred by the first processing unit for each of the rows included in the window.

10. The imaging device according to claim 9, wherein
the second processing unit
determines the position of the foreign object on a basis of a moving average of the inference results for each of the rows included in the window.

11. The imaging device according to claim 1, wherein
the first processing unit
infers the presence or absence of the foreign object for each of the rows intermittently designated in a region of interest set for the pixel region.

12. The imaging device according to claim 1, wherein
the first processing unit
infers the presence or absence of the foreign object for each of the rows on a basis of the pixel signals of the pixels included in columns further designated in the designated rows among the pixels included in the pixel region.

13. The imaging device according to claim 12, wherein
the first processing unit
infers the presence or absence of the foreign object in a region designated by the designated rows and the designated columns.

14. An imaging method executed by a processor, comprising:
an imaging step of reading and outputting, by an imaging unit including a pixel region in which a plurality of pixels is arranged in a matrix array, a pixel signal from the pixel included in the pixel region; and
a first processing step of inferring, on a basis of the pixel signals of the pixels included in designated rows among the pixels included in the pixel region, presence or absence of a foreign object for each of the rows.

15. An imaging program for causing a processor to execute:
an imaging step of reading and outputting, by an imaging unit including a pixel region in which a plurality of pixels is arranged in a matrix array, a pixel signal from the pixel included in the pixel region; and
a first processing step of inferring, on a basis of the pixel signals of the pixels included in designated rows among the pixels included in the pixel region, presence or absence of a foreign object for each of the rows.
